(19) United States
(12) Patent Application Publication
(10) Pub. No.: US 2009/0101436 A1
(43) Pub. Date: Apr. 23, 2009

(54) Telescopic aerial ladders; components; and methods

(75) Inventors: Michael J. Burman, Oscala, FL (US); Stanley E. Goodson, JR., Silver Springs, FL (US); Jeffrey D. Aiken, Appleton, WI (US)

Correspondence Address: PATTON BOGGS LLP, 8484 WESTPARK DRIVE, SUITE 900, MCLEAN, VA, 22102, US

(73) Assignees: Federal Signal - Fire Rescue Group, Oak Brook, IL (US); E-One, Ocala, FL (US)

(21) Appl. No.: 12/148,343

(22) Filed: Apr. 17, 2008

Related U.S. Application Data
(60) Provisional application No. 60/925,035, filed on Apr. 18, 2007.

(51) Int. Cl. E06C 7/08; E06C 7/02; E06C 5/04

(52) U.S. Cl. 182/69.4; 182/106; 182/207

(57) ABSTRACT

Truss arrangements utilizable in ladder sections of extendible ladder arrangements are described. Also described are ladder arrangements utilizing in the truss arrangements, and methods designed in use.

### CROSS-REFERENCE TO RELATED US PROVISIONAL APPLICATION

The present application includes the disclosure of, with edits, U.S. Provisional US 60/925,035, filed Apr. 18, 2007. The complete disclosure of U.S. 60/925,035 is incorporated herein by reference. A claim of priority to U.S. 60/925,035 is made to the extent appropriate.

### FIELD OF THE DISCLOSURE

The present disclosure generally relates to telescoping ladders, which for example, are utilized on mobile equipment such as fire fighting or rescue equipment and on various types of construction equipment. The disclosure particularly concerns components of such ladder arrangements, in particular ladder section truss arrangements.

### BACKGROUND

A variety of extendible or telescopic ladder arrangements for use in fire fighting and/or life saving equipment; and/or for construction and other aerial activities, are known. Characteristics of typical extendible (extensible) ladders include: (a) that they are anchored at one end on a moveable platform such as a truck; (b) that the ladder comprises multiple sections, for example three sections, which telescopically engage one another; (c) that the ladder sections each comprise two, spaced, side truss members with a rung arrangement extending therebetween; and, (d) that each truss member is defined by a bottom rail or beam, an upper or top rail and a plurality of load bearing support members extending therebetween.

Considerations in ladder and truss design relate to such factors as: cost and weight issues; strength issues; and, manufacturing issues. Improvements in truss designs for telescoping ladders of the type characterized herein, can be advantageous.

### SUMMARY OF THE DISCLOSURE

Truss arrangements for use in a ladder section of an extendible ladder is described. In general the truss arrangements are modified from classical truss arrangements such as Classical Pratt, Classical Warren and modified Warren arrangements. A characteristic of the described truss arrangements, is that diagonal support members are primarily used to support members between a base rail and top rail; and, selected ones of the diagonal support members differ from one another with respect to at least one of: length; acute angle of extension; and, cross-sectional size. Several example arrangements of ladder sections using the example truss arrangements, and a mobile extendible ladder assembly comprising a truck having such a ladder arrangement thereon, are described and shown.

### BRIEF DESCRIPTION OF THE DRAWINGS

FIG. 1 is a schematic side elevational view of a Classical Pratt bridge truss.

FIG. 2 is a schematic side elevational view of a Classical Warren bridge truss.

FIG. 3 is a schematic side elevational view of a modified Warren bridge truss.

FIG. 4 is a schematic side elevational view of first ladder (base section) truss arrangement according to the present disclosure.

FIG. 5 is a schematic side elevational view of a second ladder (mid fly) truss section according to the present disclosure.

FIG. 6 is a schematic side elevational view of a third ladder (top fly) truss section according to the present disclosure.

FIG. 7 is a schematic plan view of a first ladder (base) section according to the present disclosure.

FIG. 8 is a schematic side elevational view of the ladder section of FIG. 7.

FIG. 8A is a schematic, enlarged, cross-sectional view of a base rail or main rail member of the ladder section of FIGS. 7 and 8.

FIG. 8B is a schematic, enlarged, fragmentary view of a portion of FIG. 8.

FIG. 9 is a schematic, enlarged, remote or top end elevational view of the ladder section of FIGS. 7 and 8.

FIG. 10 is a schematic, fragmentary, cross-sectional view taken along line 10-10, FIG. 7.

FIG. 11 is a schematic, fragmentary, cross-sectional view taken along line 11-11, FIG. 7.

FIG. 12 is a schematic, enlarged, fragmentary view of a designated portion of the ladder section depicted in FIG. 7.

FIG. 13 is an enlarged, schematic, fragmentary view of an identified portion of the ladder arrangement in FIG. 8.

FIG. 14 is a schematic, enlarged fragmentary view of an identified portion of the ladder arrangement designated in FIG. 8.

FIG. 15 is a schematic, enlarged, fragmentary view of a designated portion of the ladder arrangement depicted in FIG. 8.

FIG. 16 is a schematic, enlarged, fragmentary view of a designated portion of the ladder arrangement depicted in FIG. 8.

FIG. 17 is a schematic, enlarged, fragmentary view of a designated portion of the ladder arrangement depicted in FIG. 8.

FIG. 18 is a schematic, fragmentary, top perspective view of a selected portion of the ladder arrangement depicted in FIG. 7.

FIG. 19 is a schematic, enlarged fragmentary, top perspective view of a portion of the ladder arrangement depicted in FIG. 7.

FIG. 20 is a schematic, fragmentary, cross-sectional view of a portion of the ladder arrangement depicted in FIG. 7.

FIG. 21 is a second, schematic, side elevational view of the ladder arrangement depicted in FIGS. 7 and 8; FIG. 21 corresponding to FIG. 8.

FIG. 22 is a second, schematic, top plan view of the ladder arrangement depicted in FIGS. 7, 8 and 21; FIG. 22 corresponding to FIG. 7.

FIG. 23 is a schematic, enlarged, fragmentary view of a designated portion of FIG. 21.

FIG. 24 is a schematic, enlarged, fragmentary view of a designated portion of FIG. 21.

FIG. 24A is a view analogous to FIG. 24, showing a modification thereto.

FIG. 25 is a schematic, enlarged, fragmentary view of a designated portion of FIG. 21.

FIG. 26 is a schematic, enlarged, fragmentary view of a designated portion of FIG. 22.

FIG. 27 is a schematic, enlarged, fragmentary cross-sectional view taken generally along line 27-27, FIG. 22.

FIG. 28 is a schematic, enlarged, fragmentary cross-sectional view taken generally along line 28-28, FIG. 22.

FIG. 28A is a schematic, enlarged, fragmentary cross-sectional view taken generally along line 28A-28A, FIG. 22.

FIG. 29 is a schematic, enlarged, top plan view of a portion of FIG. 22.

FIG. 30 is a schematic, enlarged, fragmentary view of the portion of the assembly depicted in FIG. 24, but viewed from an opposite side.

FIG. 30A is a view analogous to FIG. 30, modified analogously to FIG. 24A.

FIG. 31 is a schematic, side elevational view of a second (mid section or mid fly) ladder section according to the present disclosure.

FIG. 31A is a schematic, enlarged, cross-sectional view of a main rail or base rail portion of the ladder section depicted in FIG. 31.

FIG. 31B is a schematic, enlarged, fragmentary view of a portion of FIG. 31A.

FIG. 31C is a schematic, enlarged, fragmentary view of a portion of FIG. 31A.

FIG. 32 is a schematic top plan view of the ladder section depicted in FIG. 31.

FIG. 33 is a schematic, enlarged, fragmentary view of a designated portion of the ladder arrangement depicted in FIG. 32.

FIG. 34 is a schematic, enlarged, fragmentary view of a portion of the ladder section designated in FIG. 31.

FIG. 35 is an enlarged, schematic, fragmentary view of a designated portion of the ladder section in FIG. 31.

FIG. 36 is a schematic, enlarged, fragmentary view of a designated portion of the ladder section designated in FIG. 31.

FIG. 37 is a schematic, enlarged, fragmentary view taken generally along line 37-37, FIG. 32.

FIG. 38 is a schematic, enlarged, fragmentary view taken along line 38-38, FIG. 32.

FIG. 39 is a schematic, second cross-sectional view of a portion of FIG. 32.

FIG. 40 is a schematic, enlarged, end elevational view taken generally toward the top or remote end of the ladder section depicted in FIGS. 31 and 32.

FIG. 41 is an enlarged, fragmentary, schematic view of the features depicted in FIG. 40.

FIG. 42 is a schematic, enlarged, fragmentary, top perspective view of a portion of the ladder arrangement depicted in FIGS. 31 and 32.

FIG. 43 is a second, schematic, side elevational view of the ladder section of FIG. 31.

FIG. 44 is a schematic, enlarged, fragmentary view of a designated portion of FIG. 43.

FIG. 45 is a schematic, enlarged, fragmentary view of a designated portion of FIG. 43.

FIG. 46 is a schematic, enlarged, fragmentary view of a designated portion of FIG. 43.

FIG. 47 is a schematic, enlarged, fragmentary view of a designated portion of FIG. 43.

FIG. 48 is a schematic, enlarged, fragmentary, cross-sectional view taken along line 48-48, FIG. 43.

FIG. 49 is a schematic, enlarged, fragmentary view taken along line 49-49, FIG. 43.

FIG. 50 is a schematic, enlarged, end elevational view of a portion of the ladder section depicted in FIGS. 31, 32 and 43.

FIG. 51 is a schematic, side elevational view and third (top fly) ladder section according to the present disclosure.

FIG. 51A is a schematic, enlarged, fragmentary, cross-sectional view of a main rail or base rail section of the ladder section of FIG. 51.

FIG. 51B is a schematic, enlarged, fragmentary view of a portion of FIG. 51A.

FIG. 51C is a schematic, enlarged, fragmentary view of a portion of FIG. 51A.

FIG. 52 is a schematic, top plan view of the ladder section depicted in FIG. 51.

FIG. 53 is an enlarged, fragmentary view of a designated portion of FIG. 52 identified.

FIG. 54 is an enlarged, fragmentary, side elevational view of a portion of the ladder section designated in FIG. 51.

FIG. 55 is an enlarged, fragmentary, cross-sectional view identified in FIG. 53.

FIG. 56 is an enlarged, fragmentary, cross-sectional view identified in FIG. 54.

FIG. 57 is a schematic enlarged, fragmentary, cross-sectional view taken along line 57-57, FIG. 52.

FIG. 58 is a schematic, enlarged, fragmentary view of a portion designated in FIG. 51.

FIG. 59 is a schematic, enlarged, fragmentary view of a portion identified in FIG. 51.

FIG. 60 is an enlarged, end elevational view of a top or remote end of the ladder section depicted in FIG. 51.

FIG. 61 is a second, schematic, side elevational view of the ladder section depicted in FIG. 51.

FIG. 62 is a schematic, enlarged, fragmentary view of a portion designated in FIG. 61.

FIG. 63 is a schematic, enlarged, fragmentary view of a portion designated in FIG. 61.

FIG. 64 is a schematic, enlarged, fragmentary view of a portion designated in FIG. 61.

FIG. 65 is a schematic, enlarged, fragmentary view of a portion depicted in FIG. 61.

FIG. 66 is a schematic, enlarged, fragmentary, cross-sectional view taken generally along line 66-66, FIG. 62.

FIG. 67 is a schematic, enlarged, fragmentary view of a portion of the ladder section depicted in FIGS. 51, 52, 60 and 61.

FIG. 68 is a schematic, elevational view of the mobile ladder assembly according to the present disclosure, depicting an extendible ladder arrangement on a mobile base and in an extended orientation.

### DETAILED DESCRIPTION

### I. Extendible Ladder Arrangements, Generally

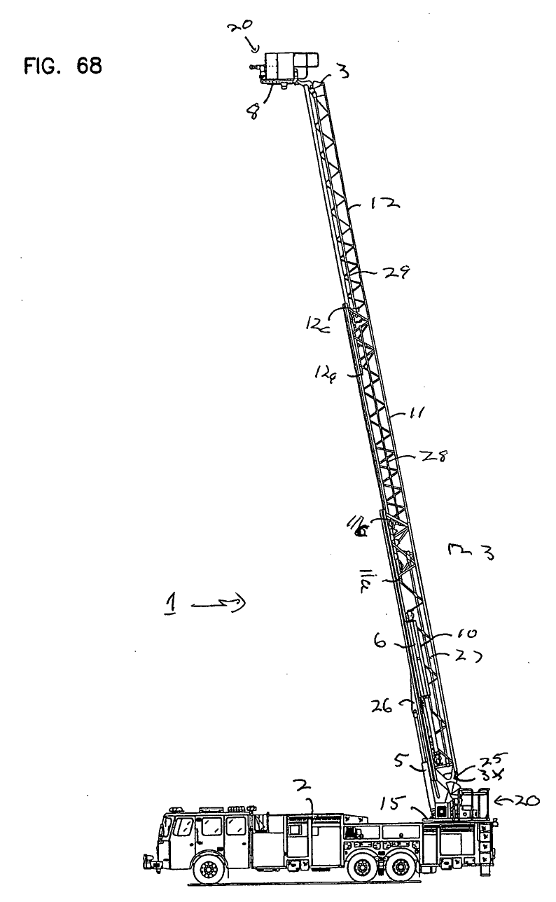

For general background relating to the arrangements according to the present disclosure, attention is directed to FIG. 68. In FIG. 68, a schematic, elevational view is provided with a type of aerial ladder arrangement of concern in the present disclosure. Such arrangements are generally mounted on a mobile platform, for example a vehicle such as a truck. The arrangements may be used, for example, in fire fighting or rescue work.

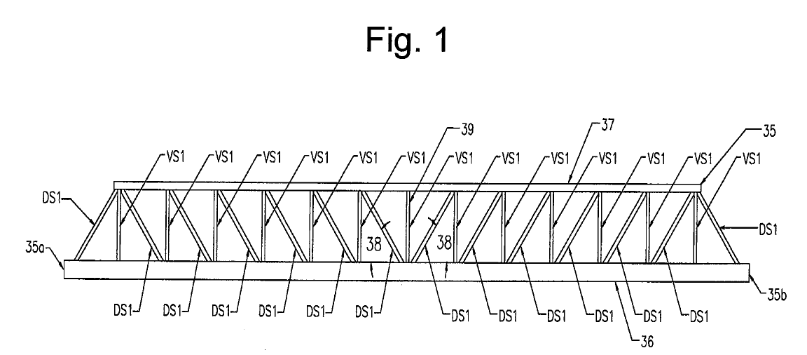

Referring to FIG. 1, mobile ladder arrangement 1 generally comprises mobile platform or truck 2, and an extendible ladder arrangement 3. The ladder arrangement 3 includes a base end 3x mounted on a rotatable turn table 15. The ladder arrangement 3 generally is telescoping, and includes appropriate equipment for extension and retraction, as well as lift. Thus ladder arrangement 3 can be fully extended or contracted for use and can be directed in any of a variety of angles of lift and directions of extension.

Referring to FIG. 68, for the arrangement 1 depicted, a lift arrangement for the ladder 3 is controlled by hydraulic arrangement 5, and extension/retraction for the telescoping ladder arrangement 3 is controlled by hydraulic arrangement 6.

The assembly 1 depicted includes a work platform 8 mounted on a remote end 3y of the ladder arrangement 3.

In a typical assembly 1, control equipment (20) for managing positioning in extension of the ladder arrangement 3 is typically provided both at or near truck 2, and on the platform 8. Alternatives are possible.

Typical arrangements such as mobile ladder arrangement 1 will be constructed to identified specifications. For example, an example fire fighting/fire rescue ladder assembly 1 might be specified as follows:

1. Total extendible height (ground to handrail) of platform 8, for example 100 feet;

2. A load rating (at full extension at 0° ; i.e., horizontal extension of the ladder) with 360° movement around the truck: 1,000 lb. live load in the platform 8 (i.e., capable of carrying a weight of persons up to 1,000 lbs.; and, also 305 lbs. fire fighting equipment and rescue equipment also carried on the platform.

In some instances, there may be a specification for the arrangement when used in pumping water during a fire fighting operation, for example as follows: during full extension of 0° (horizontal) with a 360° motion around the truck, capability of managing the water flow of 1,250 gallons per minute with 500 lbs. live load (person weight on the platform) and 305 lbs. equipment weight also on the platform.

For the example depicted in FIG. 68, the mobile ladder arrangement 1 meets these definitions by providing: (a) a ladder arrangement 3 comprising three, extendible, sections 10, 11, 12 mounted at one end on a turn table 15.

Each of the sections 10, 11, 12 can be characterized as supported in a “pseudo-cantilevered” fashion. By this, it is meant that instead of being strictly cantilevered (only supported at the end) the section is supported both at an end and at a location along its length. (Sometimes such ladder sections are sometimes called “cantilevered” in spite of being pseudo-cantilevered.)

As an example, ladder section 10 is supported both at trunnion 25 and at flange 26. Flange 26 in section 10 is supported by hydraulic arrangement 5.

Section 11 is supported along a section between end 11a and region 11c, where ladder section 11 is secured within section 10. Ladder section 12 is supported adjacent end 12a and section 12b, again along a length where ladder section 12 is telescoped within ladder section 11.

For a typical ladder arrangement such as ladder arrangement 3, a cable arrangement is controlled by hydraulic assembly 6, so that various sections 11, 12, telescope the same amount during a telescoping operation. That is, the sections 11, 12 are not typically independently telescoped. In an example arrangement, a cable/pulley arrangement would be used, for example allowing a 4/1 extension with respect to hydraulic motion. The cables are not depicted in FIG. 68, for convenience.

Conventional pulleys and cables can be used.

Still referring to FIG. 68, at 27, 28 and 29, trolly systems for electronic lines, are provided.

In general terms, each of ladder sections 10, 11 and 12, comprises first and second, side, spaced, truss sections, with a rung arrangement extending therebetween. These are discussed in further detail, below. The spaced truss arrangements in each ladder section, are constructed to manage the load characteristics for that ladder section.

### II. Background Regarding Truss Designs

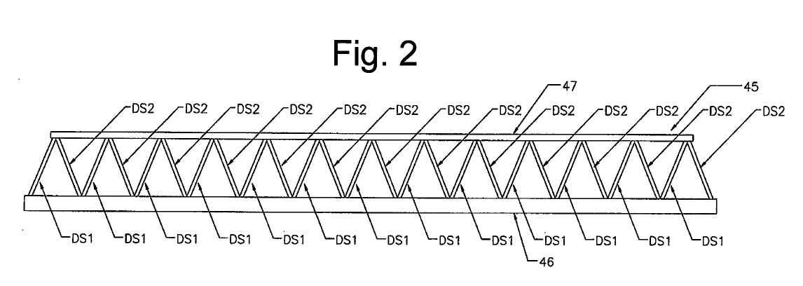

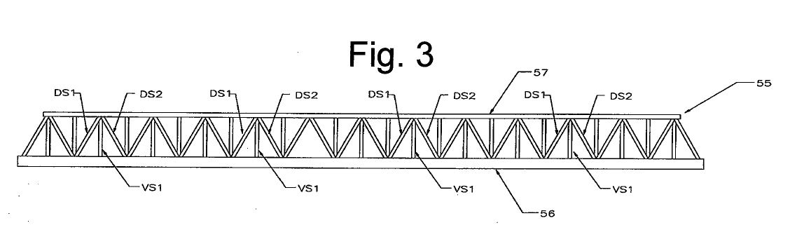

Several well-known bridge truss designs are represented in FIGS. 1-3. In FIG. 1, a classical Pratt truss is depicted schematically at 35. In FIG. 2 a Classical Warren truss is depicted schematically at 45; and, in FIG. 3, a modified Warren is depicted schematically at 55.

The truss designs of FIGS. 1-3 are truss designs typically used for bridges. In some instances, they have been adapted for use in ladder arrangements.

Ladder applications differ significantly from bridge truss applications. Classical bridge trusses have supports on either end and the worse case loading condition is in the center. Ladder sections, for example, in a fire rescue ladder, are supported only at or near one (base) end with a worse loading condition being at the opposite (top) end. That is, fire rescue ladders are cantilevered or pseudo-cantilevered arrangements.

Although Warren, Pratt and modified Warren type truss structures have been utilized in truss arrangements on fire rescue-type ladders, improvements in design are feasible because the application (supported only one end) differs substantially, from a bridge truss.

Referring to FIG. 1, a characteristic of the Classical Pratt truss 35 is that it comprises two symmetrical mirror image halves around a center line C1. A classical Pratt truss 35 comprises a main rail or base beam 36 and a parallel top rail 37. A series of supports extend between the main rail 36 and top rail 37. For the Classical Pratt truss 35, the supports comprise alternating diagonal supports DS1 and vertical supports VS1. By the term “vertical support” as used herein, reference is meant to a support between a base rail 36 and top rail 37 in a truss, which support extends generally perpendicularly to each of the rails 36, 37. The diagonal rails in a Classical Pratt truss 35 typically extend at the same acute angle of extension 38 relative to the base rail 36. Herein, angles between diagonal support members and a base rail of truss members, are sometimes characterized with respect to “an acute angle of extension.” In general when this term is used, reference is meant to an angle between the identified diagonal truss member, and an associated base rail. It is noted that in typical trusses discussed herein, the top rail and base rail are generally parallel to one another. Thus the acute angle of extension for an identified diagonal support member would be the same between the diagonal support member and the associated top rail, as between the diagonal support member and the associated base rail.

A characteristic of a Classical Pratt type 35 is that each of the diagonal supports DS1 generally extend at the same acute angle of extension 38 to the base rail.

The Classical Pratt truss 35 depicted in FIG. 1, is depicted constructed and arranged as a bridge truss, arranged with mirror image halves, around a central vertical support 39. When modified to be used as a ladder arrangement, the vertical support 391 separating sections of oppositely directed diagonal supports DS1, is typically moved toward which ever one of the ends 35a, 35b, is used as a base end, rather than being perfectly centrally positioned.

In FIG. 2, the Classical Warren bridge truss is depicted at 45. The truss 45 comprises a main rail or base rail 46 and top rail 47, which generally extend parallel to one another. A plurality of alternating diagonal supports DS1, DS2 extended between the supports 46, 47.

A typical Classical Warren truss 45 has all diagonal supports are of the same length, and extending at the same acute angle relative to the base rail 46 and top rail 47. In a Classical Warren truss 45, diagonal supports DS1, DS2 can be viewed as configured in pairs of diagonal support members, each pair comprising a support DS1 and a support DS2 extending from a vertex associated with (at) the top rail 47, while diverging from one another, in extension of the base rail 46.

In FIG. 3, a modified Warren truss 55 is depicted having a base rail 56 and top rail 57. The arrangement is analogous to arrangement 45, FIG. 3, except for the inclusion of a plurality of vertical rails VS1 positioned extending between the rails 56, 57, each vertical rail VS1 being positioned bisecting an angle defined between adjacent diagonal rails DS1, DS2.

As with the Classical Warren and Classical Pratt, a characteristic of modified Warren truss, is that each diagonal support DS1, DS2 extends at the same acute angle relative to the rails 56, 57 as the other diagonal supports DS1, DS2. Of course, in any given pair, diagonal supports DS1, DS2, diverge from one another in extension from a vertex associated on rail 57 in extension toward rail 56.

In general, all three types of truss arrangements have been utilized in extendible ladders. In U.S. Pat. No. 4,852,690, incorporated herein by reference, an extendible ladder utilizing modified Warren truss is depicted. In U.S. Pat. No. 4,396,093, incorporated herein by reference, an extendible ladder utilizing a Warren truss is depicted. As indicated previously, when a Classical Pratt truss is used in a ladder arrangement, in some instances the vertical support which separates regions of diagonals extending in opposite directions, is located closer to bottom or base end of the ladder.

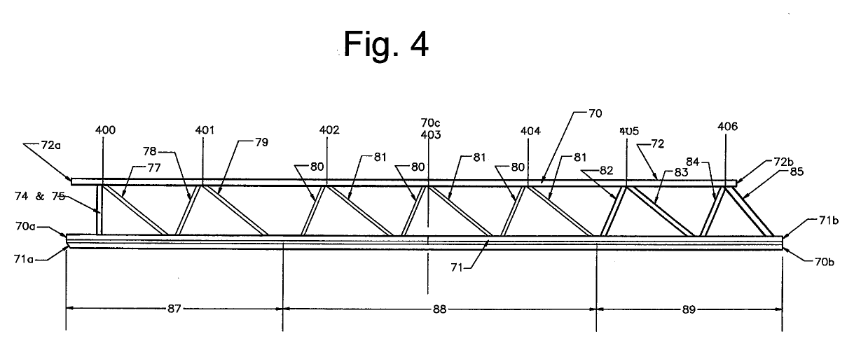

### III. Modified Truss Arrangements for Use in Telescoping Ladders; FIGS. 4-6

In general, according to the present disclosure, modified truss arrangements are described as shown, for use in an extendible ladder arrangements. A characterization of each of these truss arrangements is as follows:

1. Each truss arrangement generally includes no more than two (2), and typically no more than one (1) vertical support.

2. Each truss arrangement includes a diagonal support arrangement that will include at least two supports of at least one of: different lengths; different angles of extension; and, different cross-section. Of course, if two supports extend at different angles of extension, since the top rail and base rail are parallel, the supports also extend at different acute angles of extension.

In general terms, a variable angle of extension among selected support members allows members in compression to be made relatively short and the members in tension to be made relatively long (with respect to one another). An advantage to relatively short compression members is that smaller, lighter, compression members can be used, since buckling is less of an issue. Relatively long tension members allow for more efficient construction and buckling is not an issue for support members in tension. The use of a variable acute angle of extension also allows each member along the length of the truss member and thus ladder section, to be oriented in a way as to advantageously manage internal bending and sheer stresses. Stresses differ, along the length of each truss section in an extendible ladder.

Herein, in the context of the previous paragraph, when reference is made to a “variable acute angle of extension,” it is not necessarily meant, and indeed it is not meant, that all acute angles of extension among diagonal support members differ, along the length of the truss member. Rather it is meant that there are at least two with different acute angles of extension. Typically there are at least three that differ.

Varying beam cross-sections allows the diagonal supports to be more evenly stressed by non-uniform loading condition. This allows less material to be used when it is not needed, therefore, lightening the truss section.

In general, truss arrangements utilizing the principles described herein can be constructed with less support members per truss span, than used when a Classical Pratt, Classical Warren or modified Warren arrangement is used. This allows for the utilization of fewer support members with advantageous distributed stress. Further, savings of material and labor result. Also fewer weld operations leads to less heat distortion and residual stress issues.

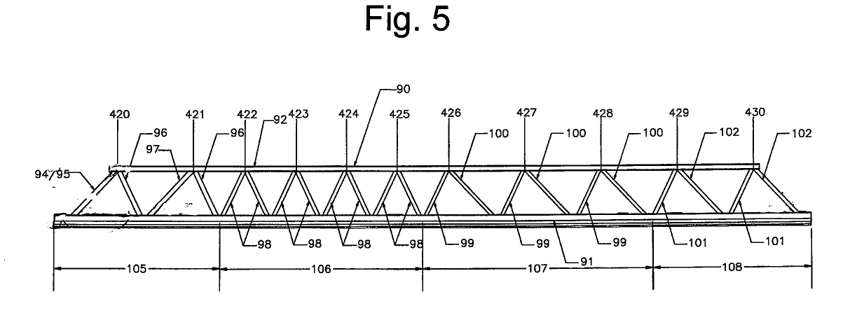

Example truss arrangements usable in ladder assembly 3, FIG. 68, are depicted herein schematically, in FIGS. 4-5.

A. Truss Section 70, FIG. 4.

Truss section 70, FIG. 4, would generally be utilized as part of a base or bottom ladder section, such as section 10, FIG. 68. Ladder section 10, would generally comprise two mirror image side trusses according to truss section 70, with rungs extending therebetween, as well as other brackets and ladder operation features. Referring to FIG. 4, truss section 70 comprises a base rail or main rail 71 and top or hand rail 72, with support arrangement 74 extending therebetween. Truss section 70 includes opposite ends 70a, 70b. As will be seen in drawings discussed below, end 70a would generally be positioned in a portion of the resulting ladder assembly 3, FIG. 68, adjacent the turn table on the truck. Thus, end 70a is a base end. The end 70b, then, is remote from the truck, and is a top or remote end.

Herein, it is important to distinguish between base end 70a of a truss arrangement and remote or top end 70b of a truss arrangement, such as arrangement 70. In a ladder arrangement, with the truss 70, the stresses can be seen to be cantilevered or in a pseudo-cantilevered arrangement, with the base end 70a anchored and the remote end 70b extended from the anchor or base.

This distinguishes the ladder truss from a bridge truss. In a bridge truss both ends are anchored or supported, i.e., at both opposite ends or base ends.

In the example truss section 70 depicted, the hand rail 72 and base rail or base bean 71 are generally parallel to one another.

Referring to FIG. 4, hand rail 72 includes opposite ends 72a, 72b and the base rail includes opposite ends 71a, 71b. Adjacent end 70a, the hand rail 72a and base rail 71a are nearly aligned, whereas in end 71b the hand rail in 72b and base rail in 70b are not aligned; i.e., 72b is closer to base 70a than end 71b. This difference relates to utilization of the truss section 70 as a base ladder section, as discussed below.

Example truss section 70 depicted includes a single vertical support member 75. The single vertical support member 75 is preferentially located as a closest support member to base end 70a, to the utilization of the truss member 70 in a base ladder section.

Other supports in support arrangement 74, comprise a first diagonal support 77, second diagonal support 78, third diagonal support 79, fourth diagonal supports 80, fifth diagonal supports 81, sixth diagonal support 82, seventh diagonal support 83, eighth diagonal support 84, and ninth diagonal support 85. In the particular example of truss 70 depicted, no two diagonal supports numbered differently are identical. That is, each differently numbered diagonal support 77-85 differs from differently numbered ones of the diagonal supports 77-85 by at least one of: cross-section; length; and, acute angle of extension.

On the other hand, identically numbered ones of the diagonal supports 77-85, are identical to one another with respect to: acute angle of extension; length; and, cross-section.

Referring to FIG. 4, truss section 70 can be seen to have three truss sections along its length, indicated at 87, 88 and 89. Section 87 is closest to base end 70a, and is configured for types of stresses associated with anchoring to the turn table of mobile assembly 1, FIG. 68. Truss section 88 is configured for the types of stresses that occur along a center portion of a corresponding ladder section. Truss section 89, which is adjacent end 70b, is configured for the type of stresses associated with pseudo-cantilevered support of an extended (telescoped) second ladder section, at that location. In reviewing FIG. 4, it can be seen that the precise definition of support members within the sections 87, 88, 89 differ, in sum total, from one another.

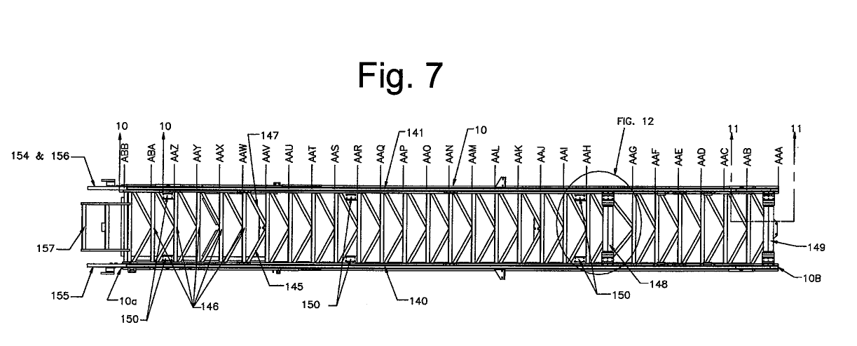

The specific relationship of the features in truss section 70, for operation of a ladder arrangement made utilizing the truss section 70, are discussed further, in association with drawings below dealing with base ladder section, see for example FIGS. 7-30.

In general terms, the characteristics of ladder truss 70 include: selected variations in selected support members, along length of the truss from first end 70a to the second end 70b; and, generation of truss sections which differ from one another, along the truss length, see sections 87, 88 and 89. Another characteristic, is that truss section 70 is asymmetrical with respect to positioning of diagonal support members 77-85, around a truss center line 70c. Another characteristic is that the truss section 70 includes relatively few truss support members 75-85, relative to a typical Classical Warren, Classical Pratt, or modified Warren truss section. In particular, the example truss section 70 depicted includes a total of 14 support members in the support arrangement 74.

Finally, in FIG. 4, the support members 75-85 can be viewed as being in pairs extending from vertices $400-406) on top rail 72 toward bottom rail 71.

B. Truss Section 90, FIG. 5.

In FIG. 5, a schematic, side elevational view is depicted of a second truss section 90. The truss section 90 is particularly configured to be utilized in a mid fly ladder section, such as ladder section 11, FIG. 68.

Truss section 90, FIG. 5, includes a first end 90a and a second end 90b. The first end 90a would be positioned closest to the turn table 15, FIG. 68. End 90b, is referred to herein as a remote or top end, since it is most remote from the turn table 15, when the ladder assembly 3 is extended. Herein, end 90a will sometimes be referred to as a “base end” or by similar terms, since, when truss section 90 is used, in a cantilevered or pseudo-cantilevered manner, the support weight is at end 90b, with end 90a anchored, for example in previous truss section 70.

Referring still to FIG. 5, truss section 90 includes a base rail 91 and a top hand rail 92, with support member arrangement 94 extending therebetween. For the example truss section 90 depicted, the base rail 91 and top rail 92 are parallel.

Since the truss section 90 is intended for use in a mid fly of an extendible ladder, the support member arrangement 94 includes no vertical support arrangements. This is because it is not anticipated that, at opposite ends, truss member 90 would include a type of load requiring a vertical support member. The diagonal support members in support member arrangement 94 comprise a first member 95, second members 96, third member 97, fourth members 98, fifth members 99, sixth members 100, seventh members 101, and eighth member 102. Each different numbered ones of the diagonal support members 95-102, differs from one another with respect to at least one of: acute angle of extension; length; and, cross-section. Each identically numbered one of the diagonal support members 95-102, is generally the same with respect to each of: acute angle of extension; length; and, cross-section.

Truss section 90 can be viewed as divided into support sections 105, 106, 107 and 108. Section 105 is a section of diagonal supports 95-97, closest to base end 98. Section 108 is the section of diagonal supports 101-102, closest to top or remote end 90b. Section 106 is a mid section adjacent base 105. Section 107 is a mid section located between section 106 and section 108.

An approximate center line of truss section 90 is indicated at 90c, between sections 106, 107.

A characteristic of truss section 90 and it includes no more than two, and typically no more than one vertical support. For the example shown there is no vertical support provided in truss section 90. The diagonal supports are divided into sections of different diagonal support arrangements, along the length of the supports 90, between the opposite ends 90a, 90b. These sections (105, 106, 107, 108) differ from one another with respect to at least one of: at least one support member length; at least one support member angle; and, at least one support cross-section.

Finally, in FIG. 5, truss member 90 can be viewed as comprising a plurality of pairs of support members 94 each having support members extending from a vertex (420-430) at rail 92 toward base rail 91.

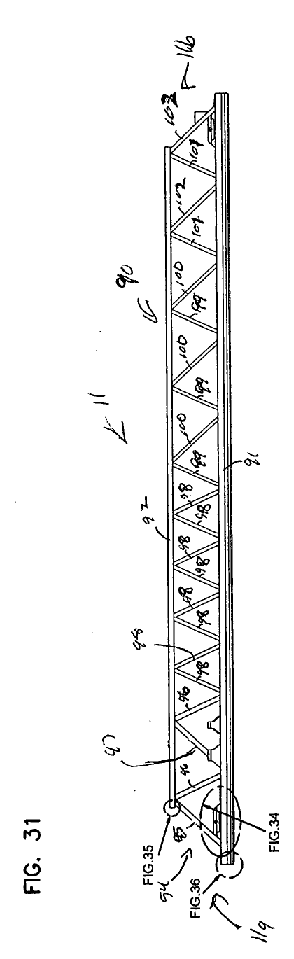

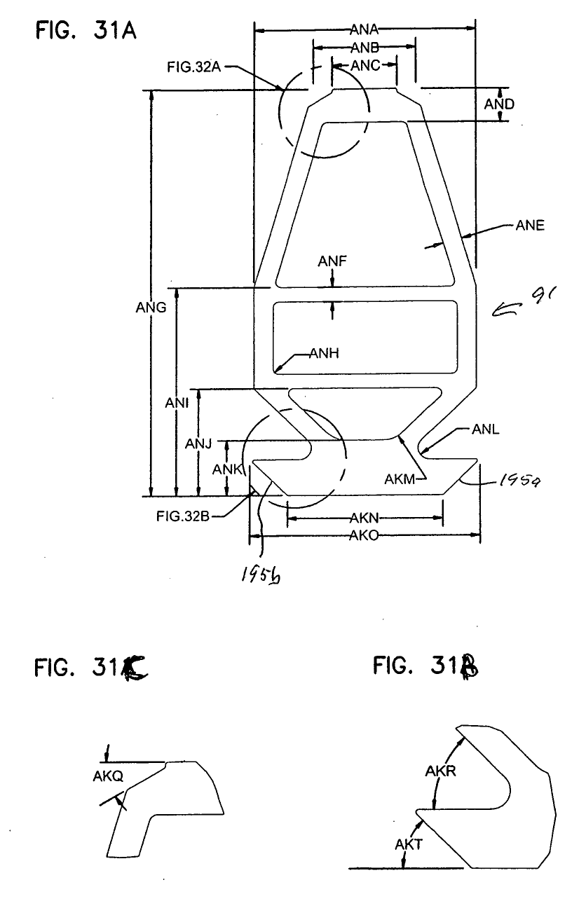

Further regarding truss section 90 is discussed below in connection with ladder section 11, FIGS. 31-50.

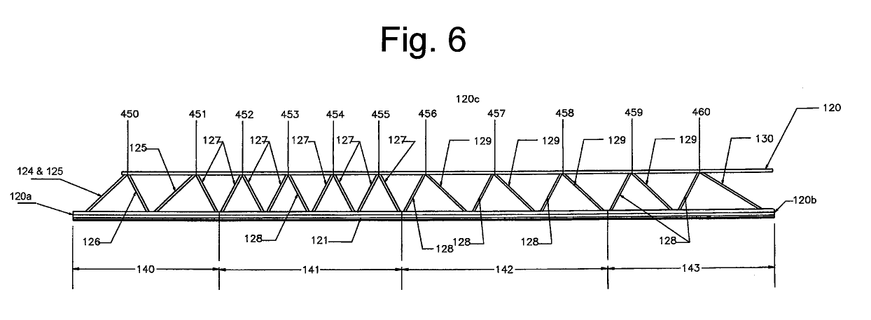

C. Truss Section 120, FIG. 6.

Reference numeral 120, FIG. 6, indicates a third truss section according to the present disclosure. Truss section 120, for example, can be used in the top fly ladder section of the ladder arrangement 3 in accord with FIG. 68. Such a ladder section is shown at 12, FIG. 68.

Referring to FIG. 6, truss section 120 includes first and second ends 120a, 120b. End 120a would generally be a base end, located more closely to turn table 15, FIG. 68. End 120b is a top remote end, when the ladder arrangement 3 is extended, and would be an end most remote from a turn table 15. End 120b would generally be utilized to support platform or bucket arrangement on a resulting ladder arrangement. As a top or remote end 20b, the end 120b can be viewed as supporting cantilevered or pseudo-cantilevered load, relative to base end 120a.

Still referring to FIG. 6, truss arrangement 120 includes a main or base rail 121 and a top or hand rail 122. The rails 121, 122 extend generally parallel to one another. The particular truss arrangement 120 includes a support arrangement 124, of individual supports, extending between the base rail 121 and top rail 122. The particular support arrangement 124 depicted includes no vertical support members. A characteristic of truss arrangement 120 is that in general it includes no more than two vertical supports, typically no more than one, and, in the example depicted no vertical support arrangements. It is noted when truss arrangement 120 is used to support platform or bucket, a member which will operate in part as a vertical support member will be included at end 120b, to support platform 9, FIG. 68.

The particular support arrangement 124 depicted includes diagonal supports, comprising: first diagonal supports 125, second diagonal support 126, third diagonal supports 127, fourth diagonal supports 128, fifth diagonal supports 129, and, sixth diagonal support 130. Identically numbered ones of supports 125-130 generally do not differ with respect to: acute angle of extension; length; and, cross-section. Supports within 125-130 with different numbers, differ with respect to at least one of: length; angle of extension; and, cross-section.

Referring to FIG. 6, it can be seen that the different diagonal supports 125-130, divide the truss 120 into sections 140, 141, 142 and 143. Section 140 is a set of diagonal supports adjacent base end 120a. Section 143 is a set of diagonal supports adjacent top or remote end 120b. Mid section 141 is located adjacent section 140 and mid section 142 is positioned between section 141 and section 143. An approximate center line of truss 120 is indicated at 120c. But for one of diagonals 128, it is approximately at a location between sections 141 and 142.

As with truss 90, truss 120 includes a region, at 141, of alternating diagonal supports 127 of the same length, acute angle and cross-section as one another. An analogous section is found, section 106, with supports 98 of truss section 90, FIG. 5.

As with previous trusses 70, 90 discussed, truss 120, FIG. 6, is configured to manage different stresses along the length of the truss between ends 120a, 120b, when incorporated in a ladder section. Section 140 is a portion that overlaps section 108 of truss section 90, when used. Section 141 is a first remote section of extension, during full extension, section 142 is a second, and section 143 a remote end or top. The varying diagonal truss arrangements among the different sections 140-143, relate to different stresses encountered, during ladder use, when collapsed, fully extended or partially extended.

In FIG. 6, the truss arrangement 120 can be viewed as having a plurality of pairs of support members 124 each extending from a vertex (450-460) at top rail 122 to base rail 121.

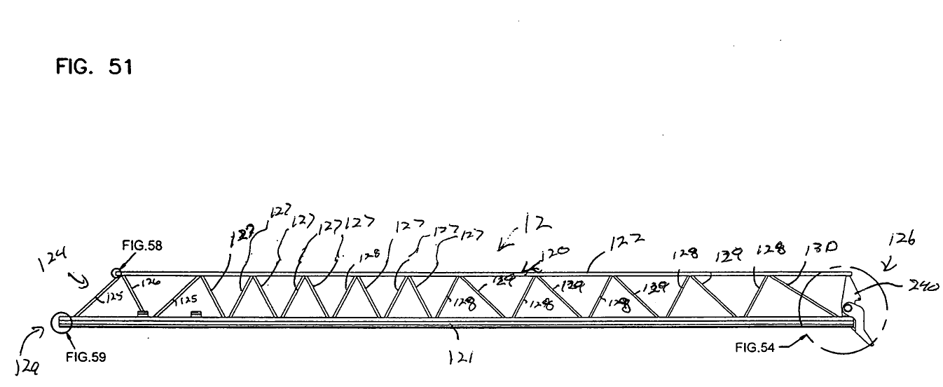

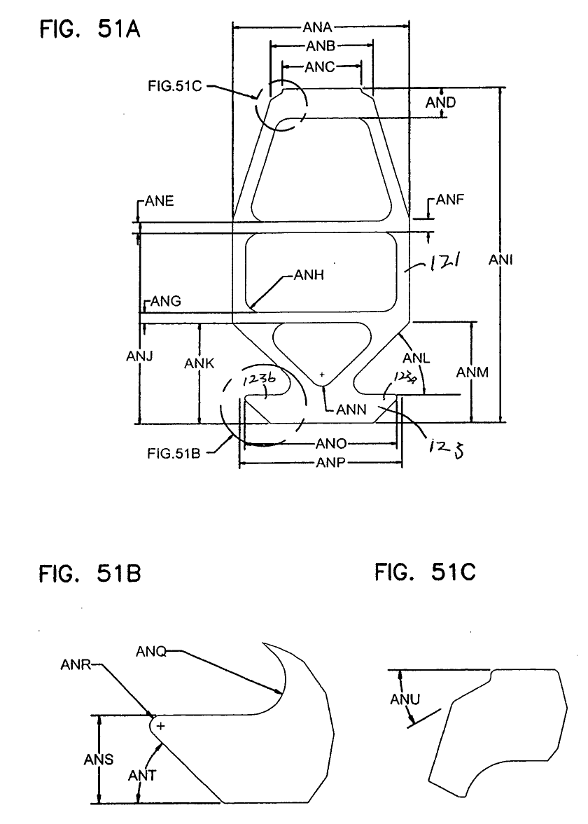

Further information regarding to incorporation of a truss corresponding to truss 120, and to a ladder assembly, is provided below in connection with ladder section 12, FIGS. 51-67.

### IV. An Example Base Ladder Section 10, FIGS. 7-67

As discussed previously, in connection with FIG. 68, a schematic, elevational view is depicted of a mobile ladder arrangement 1 including a ladder assembly 3 incorporating truss arrangements according to the present disclosure, in ladder sections 10, 11 and 12. In FIGS. 7-67, various features of the ladder sections 10, 11 and 12 are depicted.

A. Ladder Section 10, FIGS. 7-30.

In FIGS. 7-30, ladder section 10, and component sections thereof, are depicted. Ladder section 10 incorporates truss arrangements herein, generally corresponding to truss arrangement 70, FIG. 4. Referring to FIG. 7, at 10 the ladder section is depicted. The ladder comprises first and second sides, 140′, 141′, each of which comprises truss generally corresponding to truss 70, mounted as mirror images of one another. Of course when truss section 70 is used in a ladder section 10, additional ladder components may be mounted on truss section 70 used. However with respect to load bearing members of the top rail, bottom rail and support members therebetween, sides 140′, 141′ of ladder section 10 would generally correspond to truss member 70, FIG. 4.

Extending between sides 140′, 141′, is provided a rung and rung support arrangement 145. The rung and rung support arrangement 145, in general, comprises ladder rungs 146 and K-braces 147. Rung arrangement 145 includes two transfer stations or extensions 148, 149, each supported by an adjacent K-brace. The transfer stations or extensions 148, 149 include guides, discussed below, to provide for load transfer between ladder section 11 and ladder section 10.

Ladder section 10 further includes side blocks 150 thereon, which assist in maintaining alignment of ladder sections, during extension/retraction.

Ladder section 10 includes a first end 10a and a second end 10b. End 10a is generally the base end, adjacent turn table 15, FIG. 68. At end 10a, a trunnion arrangement 154 comprising first and second trunnion plates 155, 156 is located. Trunnion arrangement 154 provides for transfer of load from end 10a to a pivot arrangement mounted on turn table 15, FIG. 68. At 157, a ladder extension at end 10a is provided.

In FIG. 7, the three letter designations “AAA”-“ABC”—indicate distances from end 10b, with dimension AAA being the 0.0 dimension location. These indicated Dimensions are as follows: AAB=19.067 inch; AAC=33.067 inch; AAD=47.067 inch; AAE=61.067 inch; AAF=75.067 inch; AAG=89.067 inch; AAH=117.067 inch; AAI=131.067 inch; AAJ=145.067 inch; AAK=159.067 inch; AAL=173.067 inch; AAM=187.067 inch; AAN=201.067 inch; AAO=215.067 inch; AAP=229.067 inch; AAQ=243.067 inch; AAR=257.067 inch; AAS=271.067 inch; AAT=285.067 inch; AAU=299.067 inch; AAV=313.067 inch; AAW=327.067 inch; AAX=341.067 inch; AAY=355.067 inch; AAZ=369.067 inch; ABA=383.067 inch; and, ABB=399.327 inch. Again, each of the three letter designations indicates a distance from end 10b.

It can be seen, then, that ladder section 10 is approximately 33 feet long.

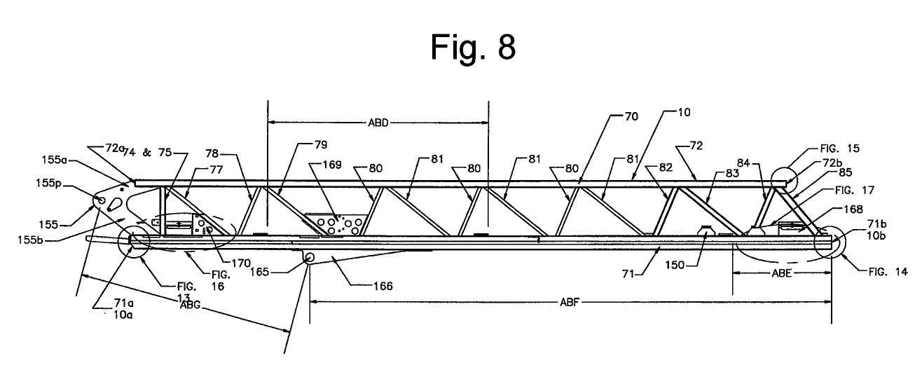

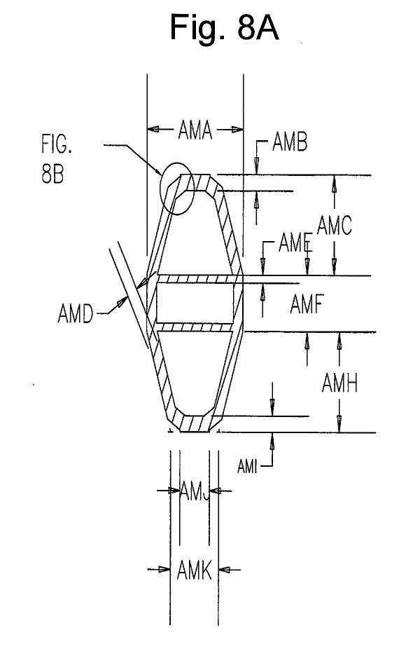

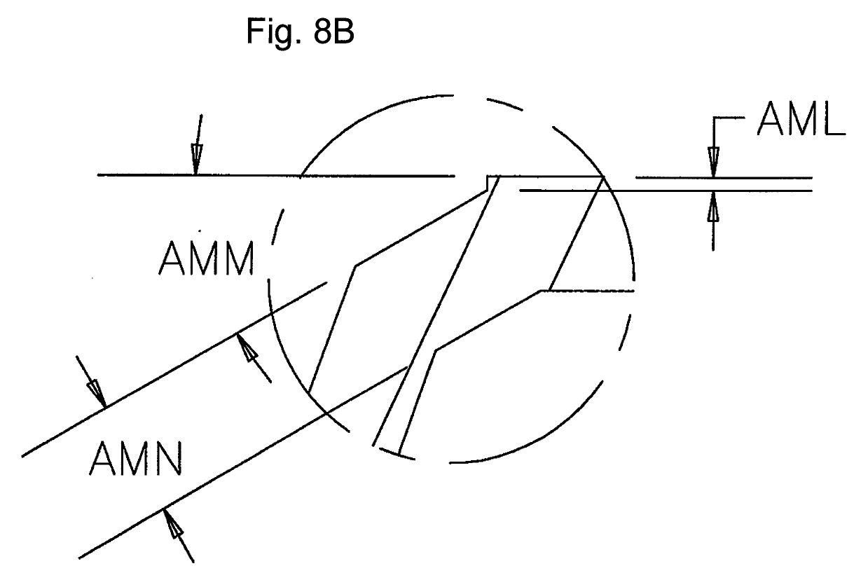

In FIG. 8, a side elevational view of ladder section 10 is depicted. It can be seen that side 140′, FIG. 7, generally comprises a truss section 70 as would opposite side 141′. Support arrangement 74 extending between top rail 72 and base rail 71 can be seen.

Trunnion member or plate 155 is viewable. The plate 155 is secured to ends 71a, 72a of rails 71, 72 respectively. From FIG. 8, extension of rail 72 of end 72a is to approximately the same distance of end 71a, and the positioning of vertical support 75 can be understood. In particular, vertical truss 75 prevents the arms of the trunnion plate 155 from being pinched together, when the ladder section 10 is loaded. Loads traveling through the hand rail 72 and base rail 71 act on the trunnion plate 155 in such a way as to pull the trunnion plate arms 155a, 155b together, creating an area of high stress on the center radius 155p of the trunnion plate 155. A vertical member 75 at extremes of the trunnion arms, 155a, 155b carries the pinching load allowing the trunnion plate 155 to do its main job of transferring the hand rail and base rail loads into the ladder pivot pin, when the ladder section 10 is mounted in ladder assembly 3, FIG. 68, for use.

In FIG. 8, some example dimensions are provided as follows: ABD=126 inch; ABE=56 inch; ABF=297.875 inch; and, ABG=122.865 inch. ABG is the distance between pivot 165 on flange 166 and pivot 155p on trunnion plate 155. Pivot 165 is a pivot point of attachment for the hydraulic arrangement 5, on ladder section 10. Pivot position 155p, is the pivot position for the trunnion plate 155 on a ladder pivot pin, on turn table 15.

In FIG. 8, some ladder features not specifically related to truss 70 configuration are indicated as follows: At 168, an anchor plate for a cable or pulley is located. At 169, a mounting plate is located, associated with the end of retraction extension cylinder arrangement 6, FIG. 68. At 170, another mounting plate arrangement associated with the extension/retraction cylinder arrangement 6, FIG. 68, is provided.

In FIG. 8A a schematic, cross-sectional view of the base rail 71 is depicted. Dimensions and angles in FIG. 8A are as follows: AMA=4.5 inch; AMB=0.5 inch; AMC=3.125 inch; AMD=0.46 inch; AME=0.25 inch; AMF=1.750 inch; AMG=8 inch; AMH=3.125 inch; AMI=0.5 inch; AMJ=1.380 inch; and, AMK=2.25 inch.

In FIG. 8B, an enlarged, fragmentary view of a portion of FIG. 8 is depicted. In FIG. 8B, dimensions and angles are as follows: AML=0.06 inch; AMM=30°; and AMN=0.5 inch.

Base rail 71 is configured to be an extruded, aluminum, member, with hollow sections.

Referring to FIG. 8, rail 70 would typically comprise a rectangular, aluminum, extruded, member. An example would be a 2.25×4.0 inch, hollow, rectangular member, 0.600 inch thick.

For the example shown, definitions for the various ones of the support 75, 77-85 are as follows: vertical support 75 would comprise a 2 inch×3 inch rectangular member, 0.50 inch thick. Support member 77 extends at an acute angle 38.6°, and comprises a 2 inch square hollow extrusion, 0.375 inch thick. Support member 78 would extend at an acute angle of extension of 67.3°, and comprise a 2 inch square hollow extrusion, 0.375 inch thick; truss support member 79 would extend at an acute angle of extension of 38.6° and comprise a 2 inch square hollow extrusion, 0.375 inch thick; truss support members 80 would each extend at an acute angle of extension of 67.3° and comprise a 2 inch×1.75 inch rectangular hollow extrusion, 0.365 inch thick; support members 81 would extend at an acute angle of extension of 38.6°, with each comprising a 2 inch×1.75 inch rectangular hollow extrusion, 0.365 inch thick; truss member 82 would extend at an acute angle of extension of 67.3° and comprise a 2 inch×3 inch rectangular hollow extrusion, 0.435 inch thick; truss member 83 would extend an acute angle of extension of 38.6° and comprise a 2 inch×3 inch rectangular hollow extrusion, 0.5 inch thick; truss member 84 would extend at an acute angle of extension of 67.3°, and comprise a 2.0 inch×3.0 inch rectangular hollow extrusion, 0.5 inch thick; and, truss member 85 would extend at an acute angle of extension of 50.1° and comprise a 2.25 inch×4 inch rectangular hollow extrusion, 0.6 inch thick.

Each of the extruded tubular members in the ladder section 10 (and also in ladder sections 11 and 12) can comprise a 6061-T6511 aluminum extrusion.

Various plate members on ladder section 10, depicted in FIG. 8 (and also in ladder sections 11 and 12), can comprise 6061-T6 plate. The turn table and supporting structures on the chassis, FIG. 68, would typically be 50,000 psi yield strength high strength low alloy steel.

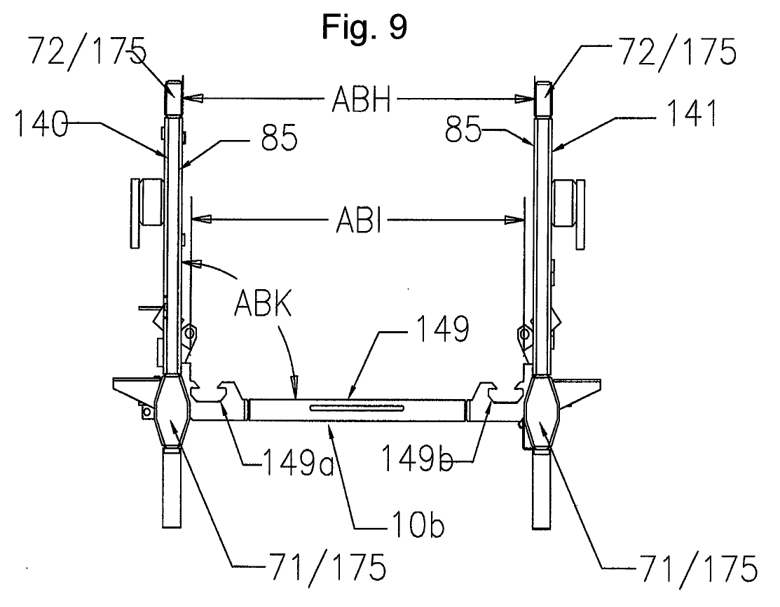

Attention is now directed to FIG. 9, which ladder section 10 is viewable, in an end view directed toward end 10b. At 149, a transfer station is depicted with guide 149a, 149b, which will receive a portion of base rails on ladder section 11, FIG. 68, sliding therein. It can be seen that the various rails 71, 72 are provided with end caps 175. In FIG. 9 the dimensions indicated are as follows: ABH=45.25 inch; ABI=42.875 inch; and, ABK=90°.

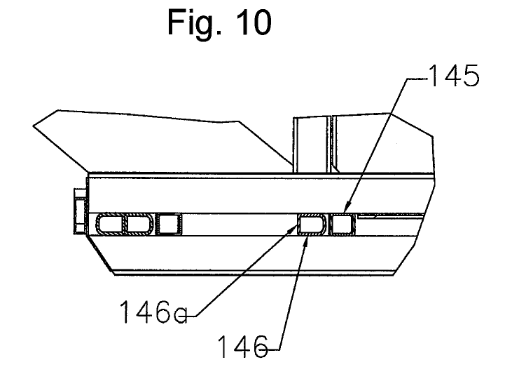

In FIG. 10, an enlarged, fragmentary cross-sectional view taken along line 10-10, FIG. 7 is viewable. In FIG. 10 a cross-sectional, hollow, D shape for the various tubular, extruded, ladder rungs 146 is viewable. In general, the straight side 146a is directed toward base or bottom end 10a, FIG. 7, for most rungs.

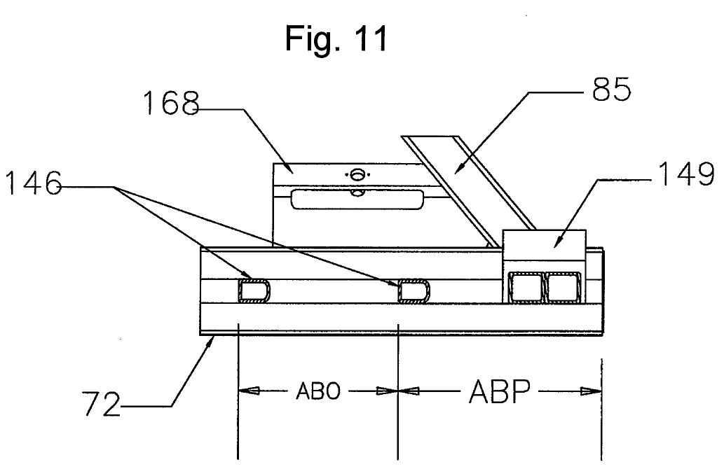

In FIG. 11, an enlarged fragmentary cross-sectional view taken along line 11-11, FIG. 7, is depicted. Dimensions indicated at FIG. 11 are as follows: ABP=19.067 inch; and, ABO=14 inch.

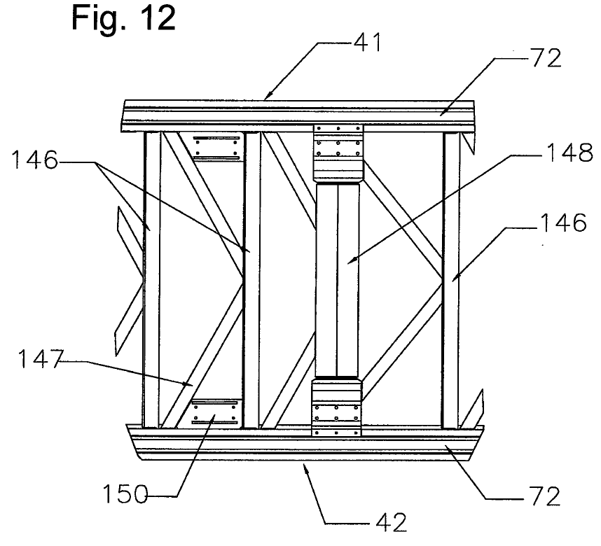

In FIG. 12, an enlarged, fragmentary plan view of a portion of ladder section 10 identified in FIG. 7, is shown.

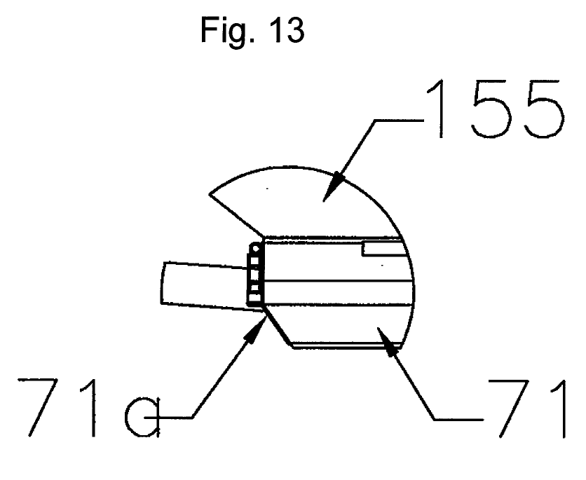

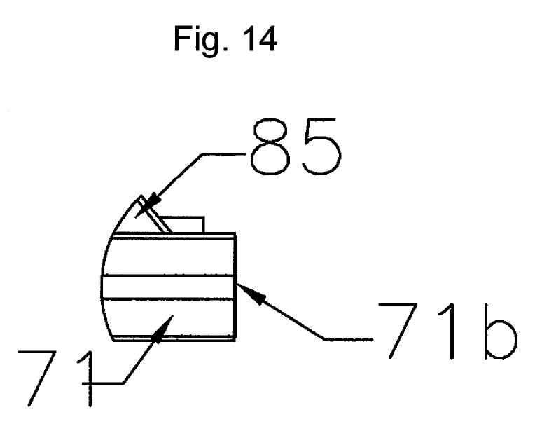

In FIG. 13, an enlarged, fragmentary view of a portion of the ladder section 10 identified in FIG. 8 is depicted. In FIG. 14 an enlarged fragmentary view of a portion of ladder section 10 identified in FIG. 8, is depicted.

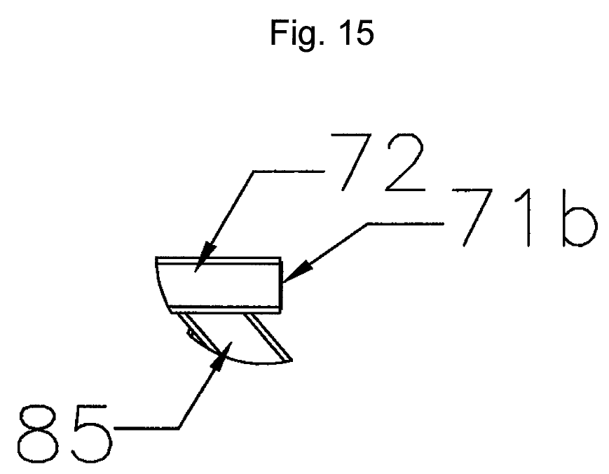

In FIG. 15 an enlarged, fragmentary view of a portion of the ladder section 10 identified in FIG. 8 is viewable.

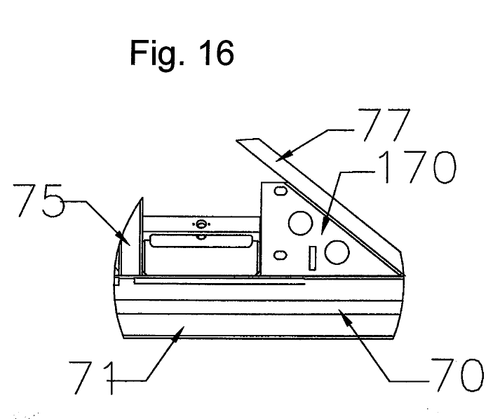

In FIG. 16 an enlarged, fragmentary view of a portion of the ladder section 10 identified in FIG. 8 is viewable.

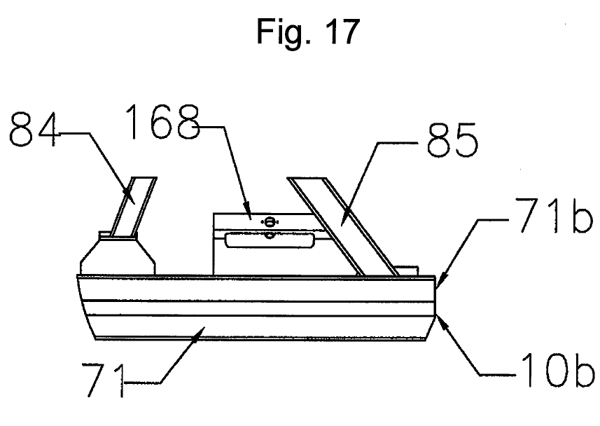

In FIG. 17 an enlarged, fragmentary view of a portion of the ladder section 10 identified in FIG. 8 is viewable.

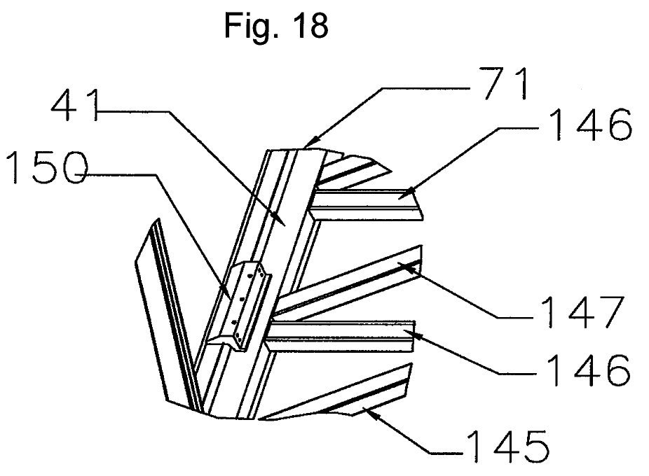

In FIG. 18 a top perspective fragmentary view is depicted of a portion of ladder section 10. Bracket or guide member 150 is viewable.

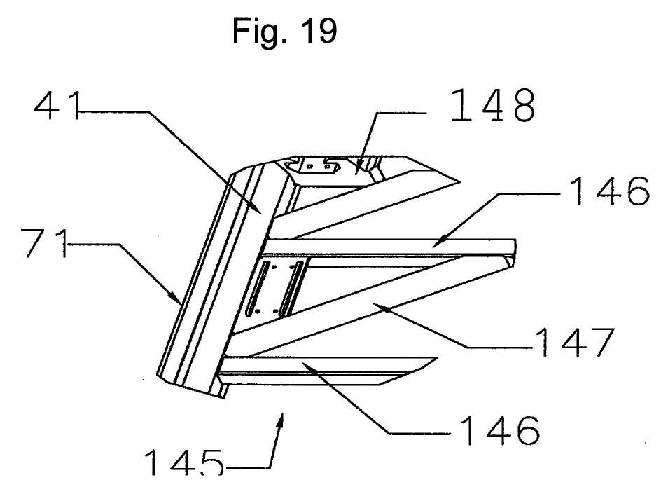

In FIG. 19, an enlarged, schematic, fragmentary, top perspective view of a portion of ladder section 10 is viewable. In FIG. 19 a portion of transfer member 148 is viewable.

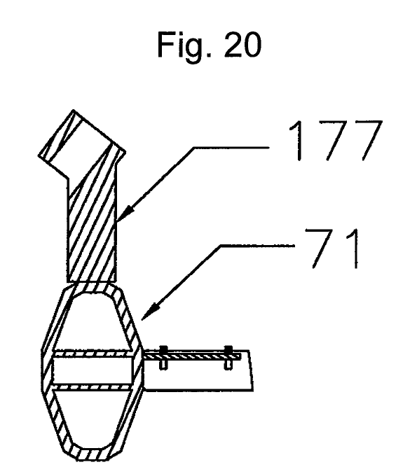

In FIG. 20 an enlarged, fragmentary, cross-sectional view of a portion of ladder section 10 is viewable. In FIG. 20 a portion of a supported guide block arrangement 177 is depicted.

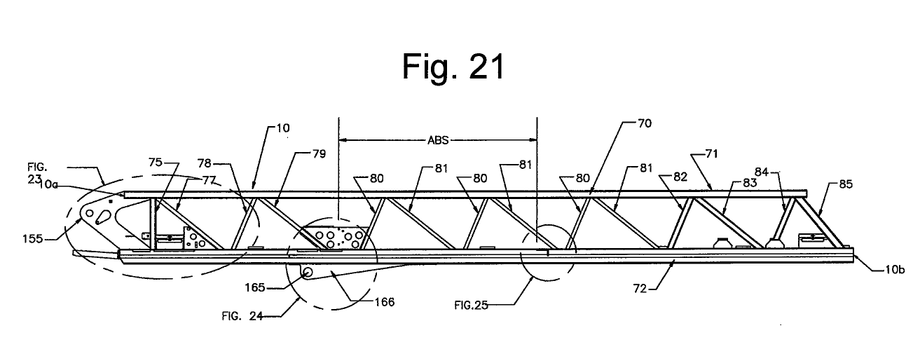

In FIG. 21, a second side elevational view of ladder section 10 is depicted. FIG. 21 is generally the same as FIG. 8, and provides for identification of additional detail features. In FIG. 21, dimension ABS is 110.495 inch.

FIG. 22 is a second top plan view of ladder section 10, and generally corresponds to FIG. 7. FIG. 22 allows for identification of still further specific detail, as follows. In FIG. 22, dimension ABT is 92.25 inch; ABU=6.75 inch; ABV=4.312 inch; ABW=94 inch; ABY=15.5 inch; and, ABX=110.495 inch.

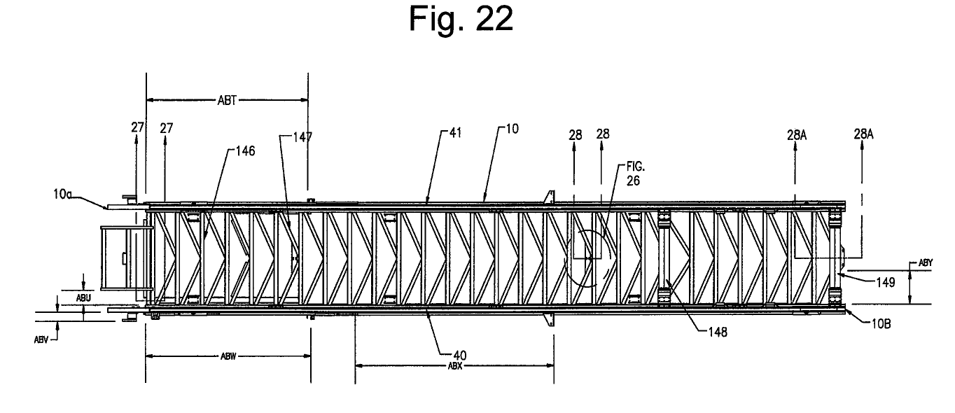

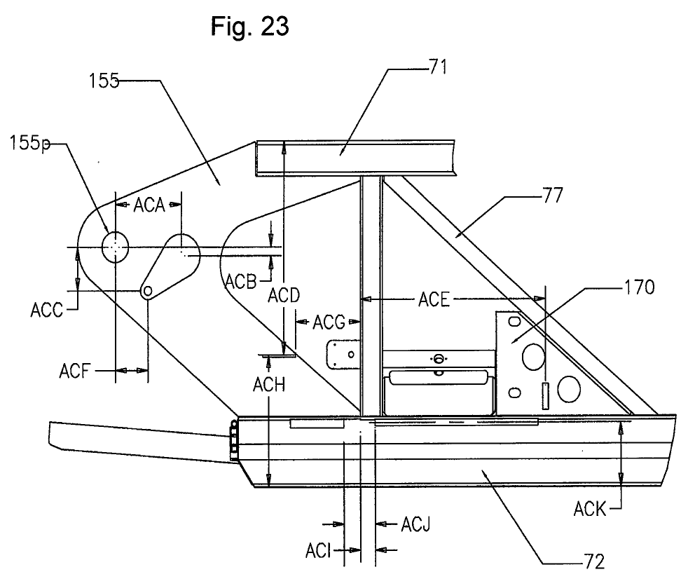

FIG. 23 is an enlarged, fragmentary view indicating a region identified in FIG. 21. In FIG. 23, indicated dimensions are as follows: ACA=8.828 inch; ACB=1.014 inch; ACC=5 inch; ACF=4.343 inch; ACD=24.375 inch; ACG=8.750 inch; ACH=15.125 inch; ACI=2.0 inch; ACJ=4.0 inch; ACE=25.0 inch; and, ACK 7.3 inch.

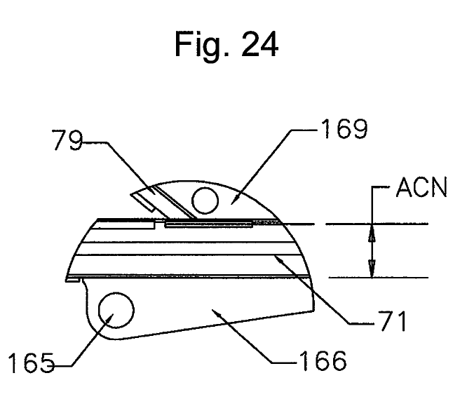

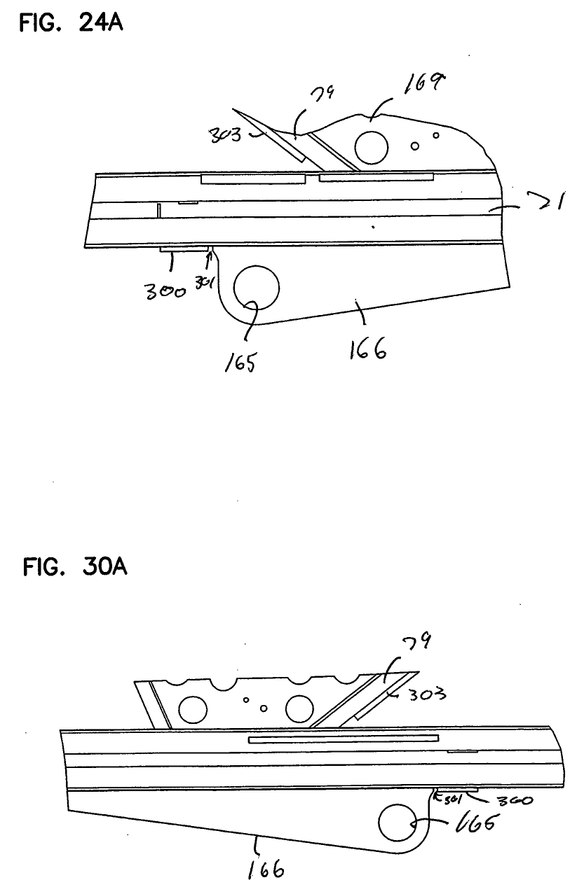

FIG. 24 is an enlarged, fragmentary view of an identified portion of the ladder section 10, FIG. 21. In FIG. 24 the identified dimension is as follows: ACN=7.3 inch.

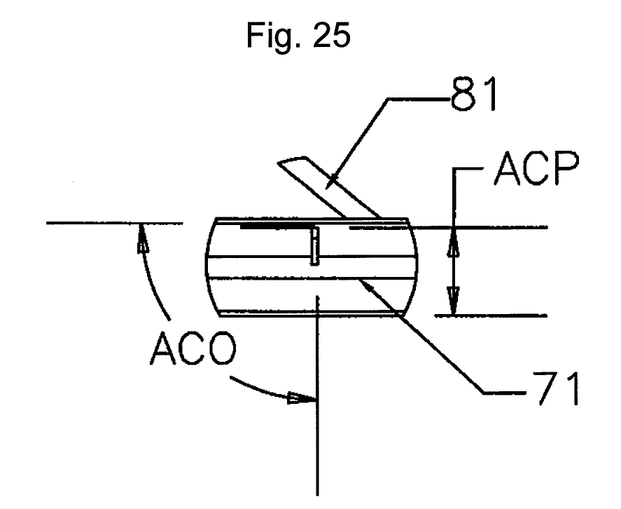

FIG. 25 is an enlarged, fragmentary view of an identified portion of FIG. 21. In FIG. 25, angle ACO is 90°, and dimension ACP is 7.25 inch.

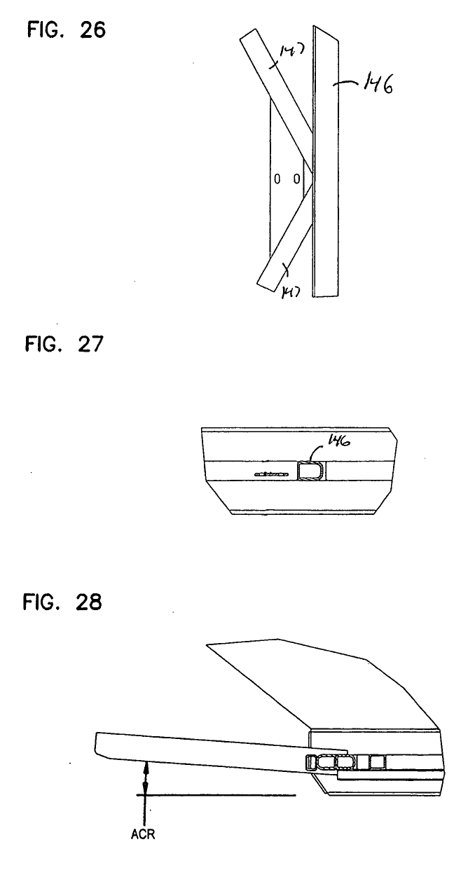

FIG. 26 is a fragmentary, enlarged plan view of a portion of the ladder section 10, identified in FIG. 22.

FIG. 27 is an enlarged, fragmentary cross-sectional view taken generally along line 27-27, FIG. 22. Rung 146 is viewable.

FIG. 28 is an enlarged, fragmentary, cross-sectional view taken along line 28-28, FIG. 22. The angle ACR indicated is 4°.

FIG. 28A is an enlarged, fragmentary, cross-sectional view taken along line 28A-28A, FIG. 22.

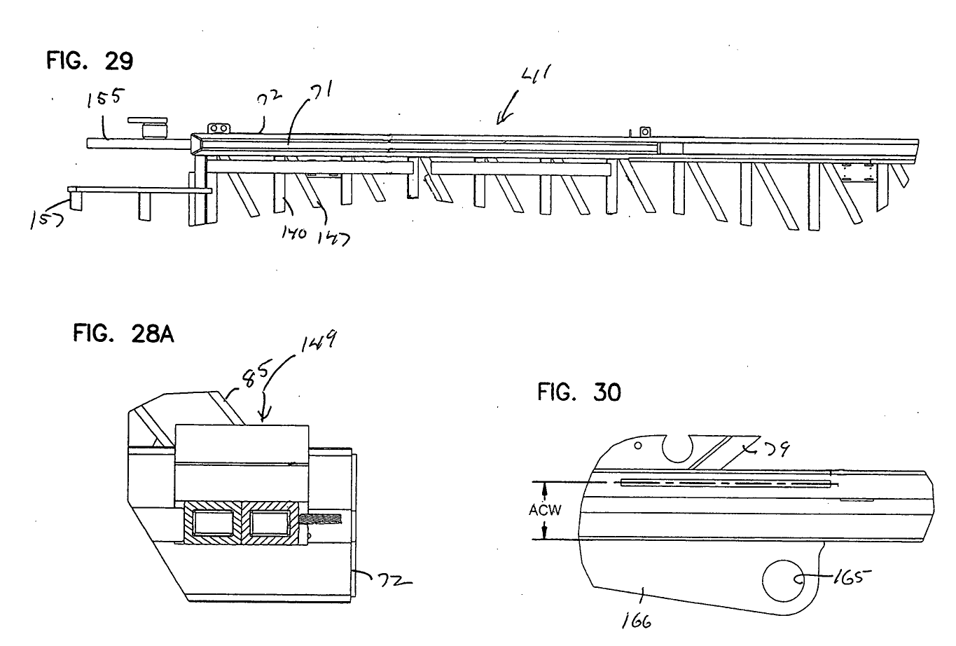

FIG. 29 is an enlarged, fragmentary, plan view of a portion of FIG. 22.

FIG. 30 is an opposite side view of FIG. 24. In FIG. 30, dimension ACW is 6.5 inch.

B. The Ladder Mid Fly Section 11, FIGS. 31-50.

In FIG. 31, a side elevational view of center section 11, FIG. 68 is provided. Ladder section 11 generally comprises a center or mid fly for the extendible ladder arrangement 3. It can be seen from a review of FIG. 31, that ladder section 11 generally includes truss arrangements in accord with that discussed above for FIG. 5, at 90.

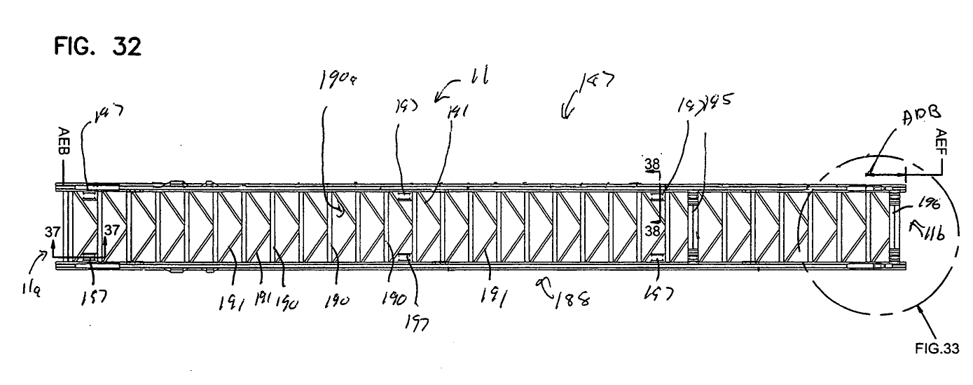

In FIG. 32 a top plan view of ladder section 11 is viewable. It can be seen that ladder section 11 comprises opposite sides 187, 188, with rung and rung support arrangement 190a extending therebetween.

Referring to FIG. 31, the truss arrangement 90 can include a top rail 92 comprising a 2 inch×3 inch hollow rectangular extrusion, 0.5 inch thick. The base member 91 is depicted in more detail, in FIGS. 31A-31C.

Referring to FIG. 31A, base rail 91 is viewable in cross-section. Dimensions and angles in FIG. 31A, are generally as follows: ANA=3.75 inch; ANB=1.75 inch; ANC=1.10 inch; AND=0.563 inch; ANE=0.320 inch; ANF=0.250 inch; ANG=7 inch; ANH=0.09 inch radius; ANI=3.625 inch; ANJ=1.875 inch; ANK=0.966 inch; ANL=0.2 inch radius; AKM=0.5 inch radius; AKN=2.625 inch; and, AKO=3.875 inch.

Referring still to FIG. 31A, it can be seen base rail 91 includes a lower extension or guide 195 having opposite flanges 195a, 195b to be received within guide members 148, 149, FIGS. 22 and 9.

FIG. 31B is an enlarged, fragmentary portion of FIG. 31A, with angles as follows: AKR=45°; and, AKT=45°.

FIG. 31C is an enlarged, fragmentary view of a portion of FIG. 31A, with angle AKQ being 30°.

For mid-section 11, FIG. 31, the definition of the supports 95-102, is generally as follows: support member 95 extends at an acute extension angle of 46.7°, and comprises a 2.5 inch×2 inch rectangular extrusion, 0.45 inch thick; support members 96 extend at an acute extension angle of 64.7°, and each generally comprises a 2.5 inch×2.0 inch hollow rectangular extrusion, 0.45 inch thick; support member 97 generally extends at an acute extension angle of 46.70 and comprises a 2.5 inch×2.0 inch hollow rectangular extrusion, 0.45 inch thick; support members 98, FIG. 31, each have an acute extension angle of 64.7° and each comprises a 2 inch square hollow extrusion, 0.375 inch thick.

Extension members 99 each extend at an acute extension angle of 64.7° and each comprise a 1.75 inch×2.0 inch hollow rectangular extrusion, 0.12×0.31 inch thick. Support members 100 each extend at an acute extension angle of 46.7° and each comprises a 1.75 inch×2.0 inch hollow rectangular extrusion, 0.12×0.31 inch tick. Support members 101 each extend at an acute extension angle of 64.7° and each comprises a 2.0 inch square hollow extrusion, 0.375 inch thick. Support members 102 each extend at an acute extension angle of 46.7° and each comprises a 2.0 inch square hollow extrusion, 0.375 inch thick.

FIG. 32, again, is a top plan view of ladder section 11. Dimension AEF (19.130 inch) is a distance from end 11b. Location AEB is an end of a top rail on ladder section 11. Dimension AEB (394.26 inch) indicates a distance from point ADB. Ladder section 32 is about 34 feet long.

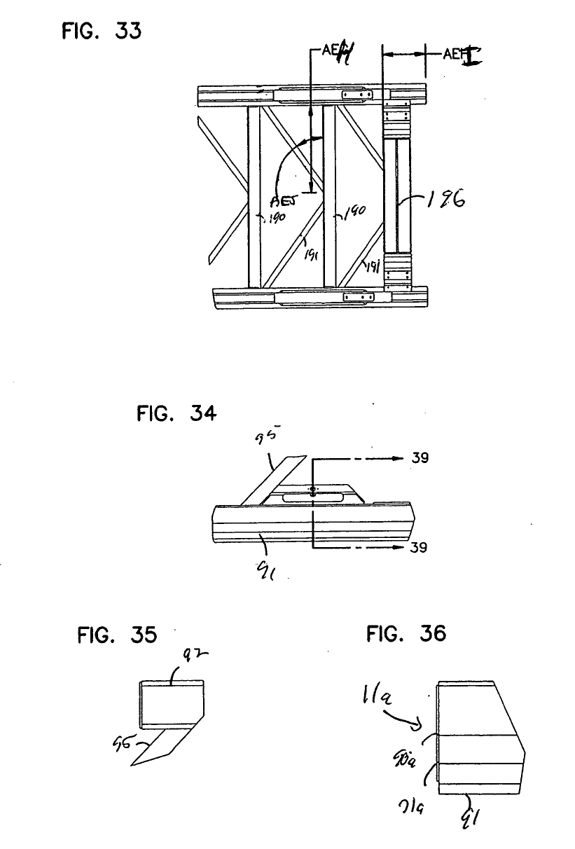

In FIG. 32, rung arrangement 190a is depicted, comprising rungs 190 and K supports 191. Transfer rails are located at 195 and 196. Guides are located at 197. These structures identified operate analogously to analogously identified structures for ladder section 10. FIG. 33 is an enlarged, fragmentary view of a portion identified in FIG. 32.

Referring to FIG. 33, dimensions indicated are as follows: AEI=7.87 inch; dimension AEH=16.409 inch; and angle AEJ=35°.

FIG. 34 is an enlarged, fragmentary view of an identified portion of FIG. 31. FIG. 35 is an enlarged, fragmentary view of a portion indicated in FIG. 31.

FIG. 36 is an enlarged, fragmentary view of a portion of FIG. 31.

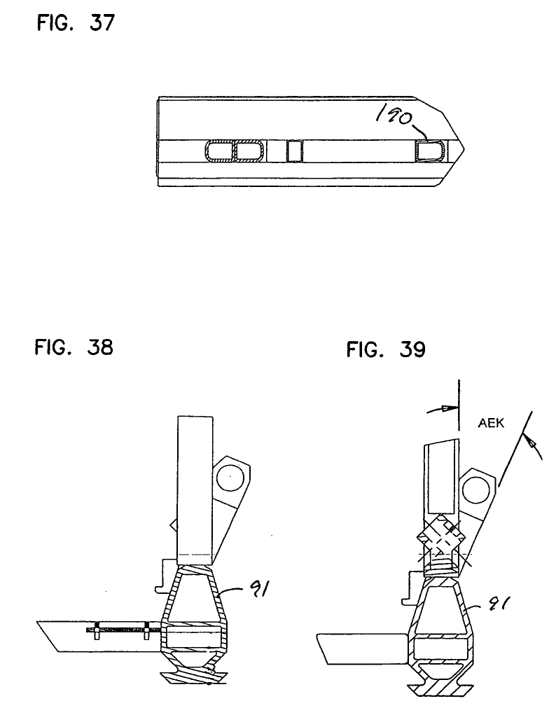

FIG. 37 is an enlarged, fragmentary, cross-sectional view taken generally along line 37-37, FIG. 32. Here the rung 190 is seen to have a D shaped cross-section.

FIG. 38 is an enlarged, fragmentary, cross-sectional view taken generally along line 38-38, FIG. 32.

FIG. 39 is an enlarged, fragmentary, cross-sectional view taken generally along line 39-39, FIG. 34. In FIG. 39, angle AEK is 45°.

FIG. 40 is a schematic end elevational view taken generally toward ladder end 11b, FIG. 31. In FIG. 40, dimensions are as follows: AEL=42 inch and AEM=34 inch.

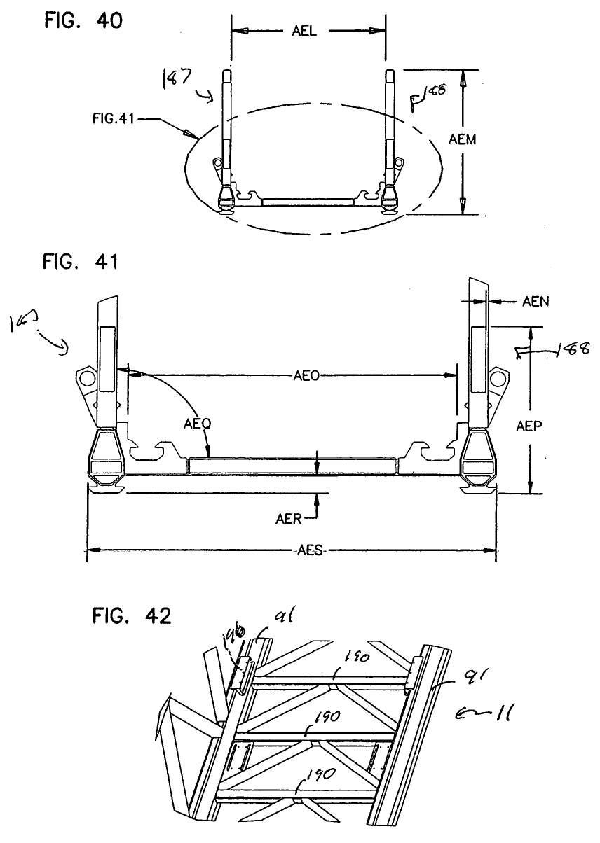

FIG. 41 is an enlarged, fragmentary view of a portion of FIG. 40. In FIG. 41, indicated dimensions are as follows: AEO=33.874 inch; AEN=0.25 inch; AEP=17.75 inch; AER=2.02 inch; AEQ=90°; and, AES=42 inch.

FIG. 42 is an enlarged, fragmentary view of a portion of FIG. 32, generally allowing for viewing of one of the brackets or guides 196.

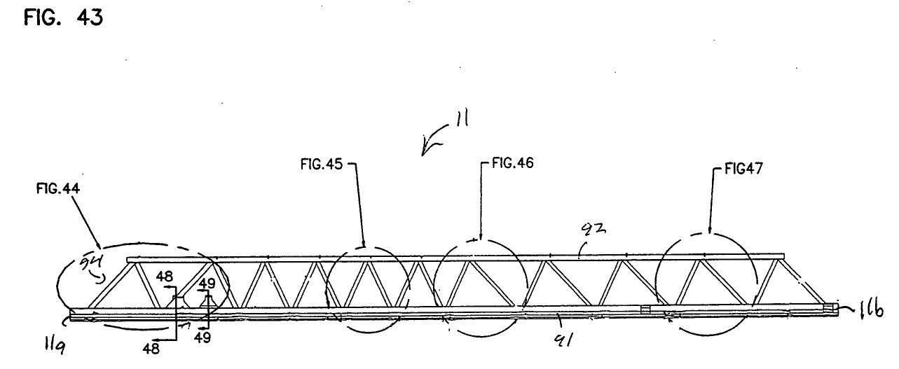

FIG. 43 is a second side elevational view of ladder section 11, generally corresponding to FIG. 32.

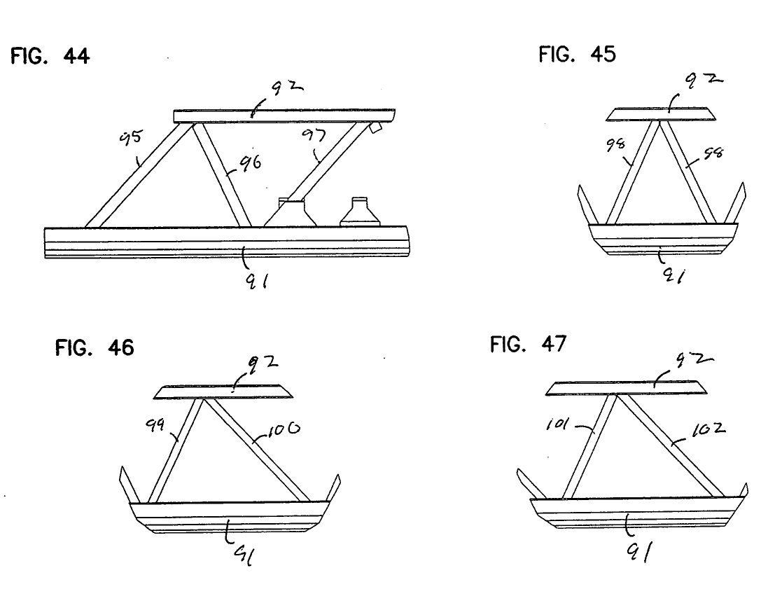

In FIG. 44, an enlarged, fragmentary view of a portion of FIG. 43, is indicated.

FIG. 45 is an enlarged, fragmentary view of an identified portion of FIG. 43.

FIG. 46 is an enlarged, fragmentary view of an identified portion of FIG. 43.

FIG. 47 is an enlarged, fragmentary view of an identified portion of FIG. 43.

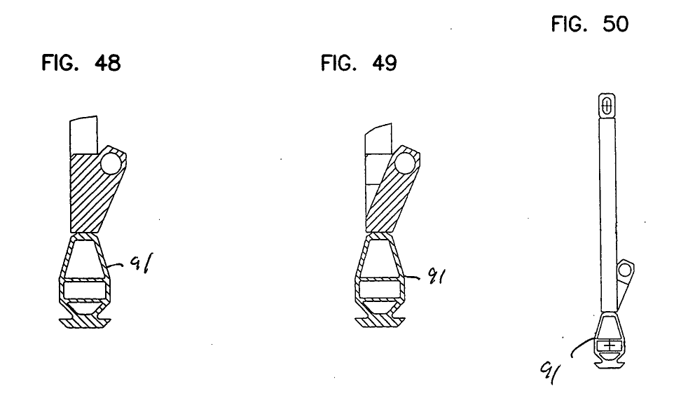

FIG. 48 is an enlarged, cross-sectional view of a selected portion of FIG. 31, as is FIG. 49.

FIG. 50 is an end elevational view of a portion of a side of ladder section 11, FIG. 32.

C. The Top Fly Ladder Section 12, FIGS. 51-67.

In FIG. 51, ladder section 12, used as the top fly end ladder section 12, FIG. 68 is viewable. Ladder end 12a generally corresponds to a base end closest to turn table 15. Ladder section end 12b is the most remote tip or top end of ladder extension 12, adjacent support platform 8.

Thus, in use ladder extension 12 has a base end 12a and a remote end 12b, the remote end 12b comprising a load supported in a cantilevered or pseudo-cantilevered fashion on the remainder of the ladder, for example ladder extension section 11.

Referring to FIG. 51, a side elevational view, it can be seen that ladder 12 generally comprises side trusses 120 in accord with that discussed above, for FIG. 6. The truss 120, then, comprises base rail 121 and top or hand rail 122. Truss support arrangement 124 comprises supports 125-130, as previously discussed.

In addition, FIG. 12, other structural features that would be included in the truss member 20 when used as ladder section 12 are provided. Particular attention is paid to end support 240 which both provides load transfer between rails 121, 122, and provides for support of platform 8, FIG. 68.

In FIG. 51, rail 122, the hand rail, will generally comprise a 1.5 inch×2.0 inch hollow rectangular extrusion, 0.305 inch thick. The base rail 121 is depicted in more detail, in connection with FIGS. 51A-51C.

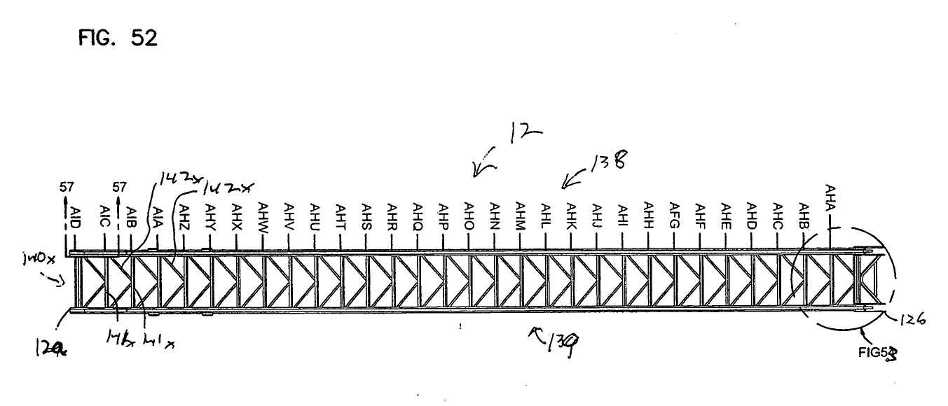

In FIG. 52, the ladder section 12 includes sides 138, 139 and rung arrangement 140x comprising rungs 141x and K braces (supports) 142x. Truss members according to FIG. 7 are used in sides 138, 139.

Referring to FIG. 51A, the base rail 121 is shown in an enlarged cross-sectional view. Dimensions and angles in FIG. 51A are as follows: ANA=3 inch; ANB=1.75 inch; ANC=1.34 inch; AND=0.5 inch; ANE=0.188 inch; ANF=0.220 inch; ANG=0.188 inch; ANH=0.250 inch radius; ANI=5.75 inch; ANJ=3.5 inch; ANK=1.75 inch; ANL=45°; ANN=0.2 inch radius; ANM=1.75 inch; ANO=2.575 inch; and, ANP=2.75 inch.

In FIG. 51A, it can be seen that the base rail 122 includes a slide or guide member 123 thereon with flanges 123a, 123b, for engagement with load transfer members 195, 196, FIG. 32, in the mid section 11.

FIG. 51B is an enlarged fragmentary view of a portion of FIG. 51a, with dimensions and angles as follows: ANQ=0.20 inch radius; ANR=0.62 inch radius; ANS=0.5 inch; and, ANT=45°.

FIG. 51C is an enlarged fragmentary view of a portion of FIG. 51A, with angle ANU being 30°.

Referring again to FIG. 51, support members 125-131 can be generally as follows: support members 125 extends at an acute angle of extension of 43.5° and each comprises a 1.5 inch square hollow extrusion, 0.250 inch thick; support member 126 extends at an acute extension angle of 62.2° and comprises a 1.5 inch square hollow extrusion, 0.25 inch thick; support members 127 each extend at an acute extension angle of 62.2° and each generally comprises 1.5 inch square hollow extrusion, 0.25 inch thick; support members 128, each extend at an acute angle of 62.2°, and each comprises a 1.5 inch×1.25 inch hollow rectangular extrusion, 0.125×0.10 inch thick. Support members 129 each extend at an acute angle of 43.5°, and each comprises a 1.5 inch×1.25 inch hollow rectangular extrusion, 0.125×0.10 inch thick; and, support members 130 each extend at an acute angle of 33.4° and comprises a 1.5 inch×1.25 inch hollow rectangular extrusion, 0.125 inch×0.10 inch thick.

In FIG. 52, a top plan view of ladder section 12 is viewable, with sides 138, 139. Dimension AHA-AID indicate a general distance from and end as follows: AHA=18.5 inch; AHB=32.5 inch; AHC=46.5 inch; AHD=60.5 inch; AHE=74.5 inch; AHF=88.5 inch; AHG=102.5 inch; AHH=116.5 inch; AHI=130.5 inch; AHJ=144.5 inch; AHK=158.5 inch; AHL=172.5 inch; AHM=186.5 inch; AHN=200.5 inch; AHO=214.5 inch; AHP=228.5 inch; AHQ=242.5 inch; AHR=256.5 inch; AHS=270.5 inch; AHT=284.5 inch; AHU=298.5 inch; AHV=312.5 inch; AHW=326.5 inch; AHX=340.5 inch; AHY=354.5 inch; AHZ=368.5 inch; AIA=382.5 inch; AIB=396.26 inch; AIC=410.5; and, AID=426.26.

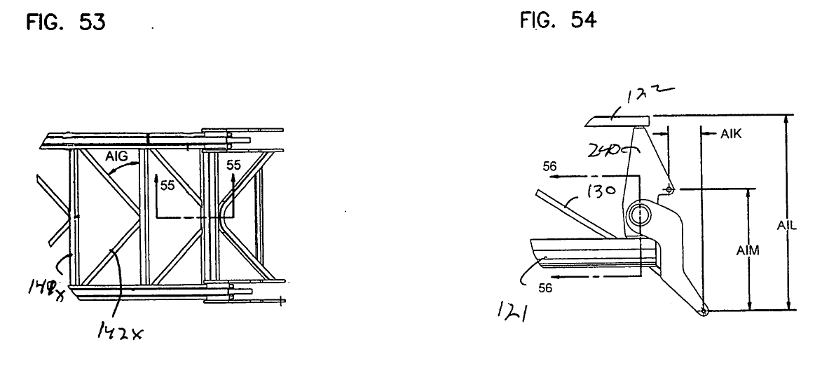

FIG. 53 is an enlarged, fragmentary view of a designated portion of FIG. 52; angle AIG is 42°.

FIG. 54 is an enlarged, fragmentary view of a designated portion of FIG. 51 with dimensions indicated as follows: AIL=39 inch; AIM=24.578 inch; AIK=6.630 inch.

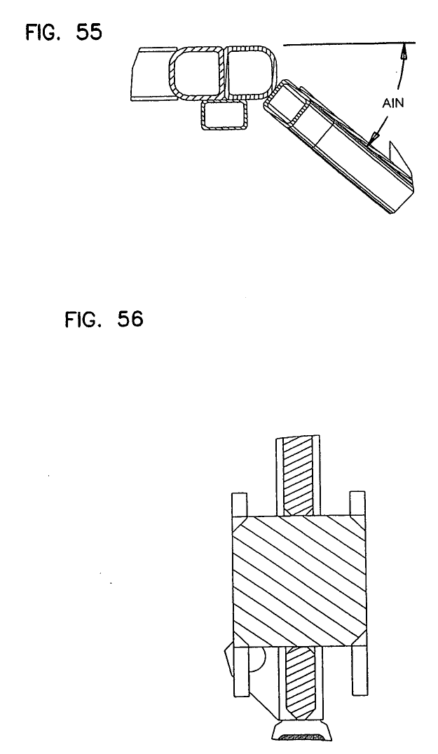

FIG. 55 is a cross-sectional view taken along line 55-55, FIG. 53. Dimension AIN is 41°.

FIG. 56 is a cross-sectional view taken along line 56-56, FIG. 54.

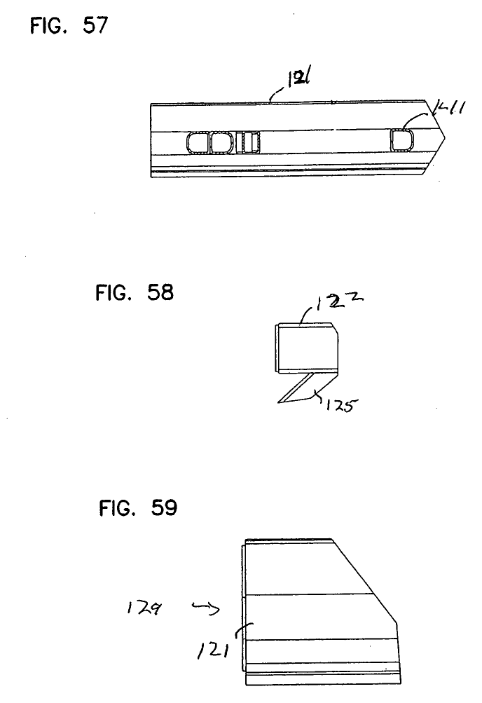

FIG. 57 is a cross-sectional view taken along line 57-57, FIG. 52.

FIG. 58 is an enlarged, fragmentary view of a designated portion in FIG. 51.

FIG. 59 is an enlarged, fragmentary view of a designated portion in FIG. 51.

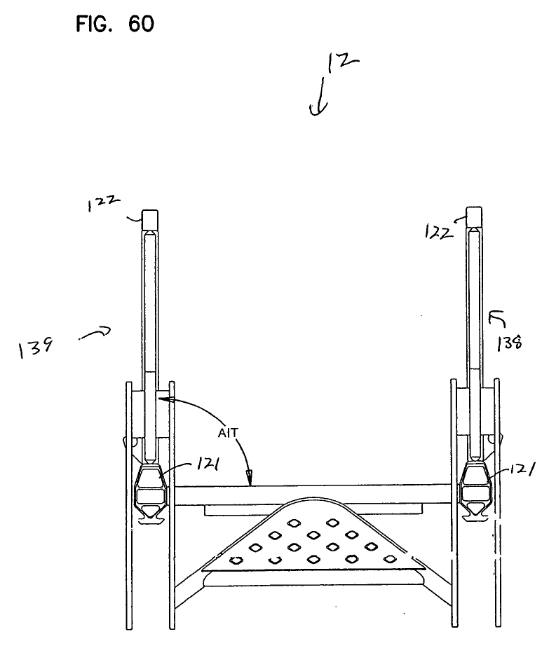

FIG. 60 is an enlarged, end elevational view of FIG. 52, taken toward remote end 12b. In FIG. 60, angle AIT is 90°.

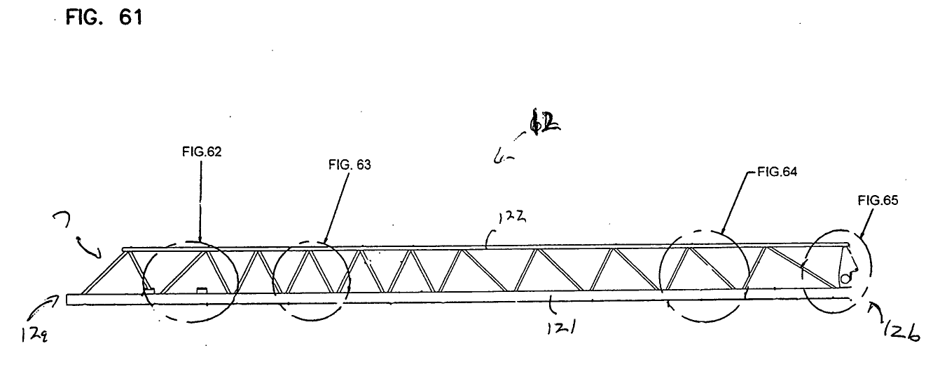

FIG. 61 is a second side elevational view of the ladder arrangement, corresponding to FIG. 51.

It is noted that the entire truss section 12 is about 35 feet long.

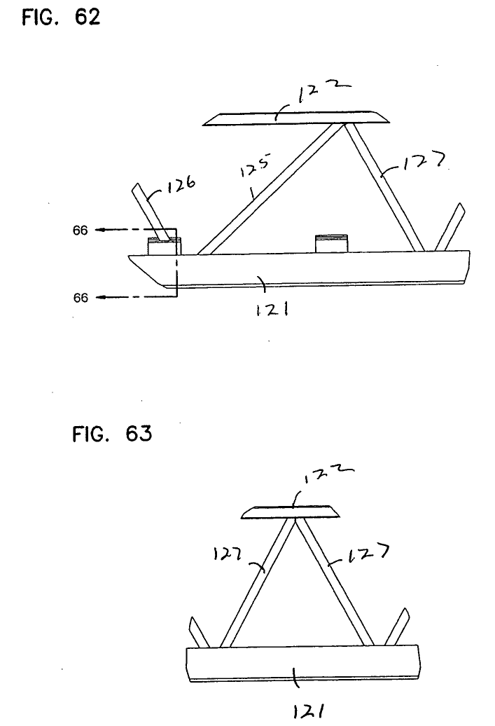

FIG. 62 is an enlarged, fragmentary view of a designated portion of FIG. 61.

FIG. 63 is an enlarged, fragmentary view of a designated portion of FIG. 61.

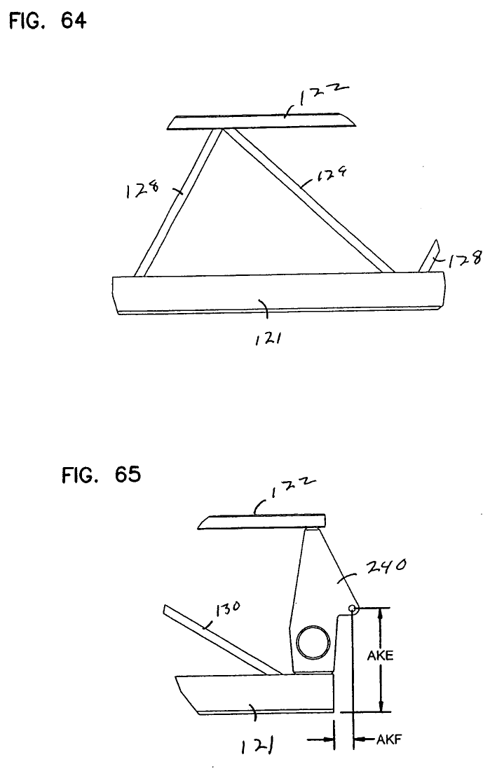

FIG. 64 is an enlarged, fragmentary view of a designated portion of FIG. 61.

FIG. 65 is an enlarged, fragmentary view of a designated portion of FIG. 61. In FIG. 65, dimension AKE=15.568 inch; and AKF=2.870 inch.

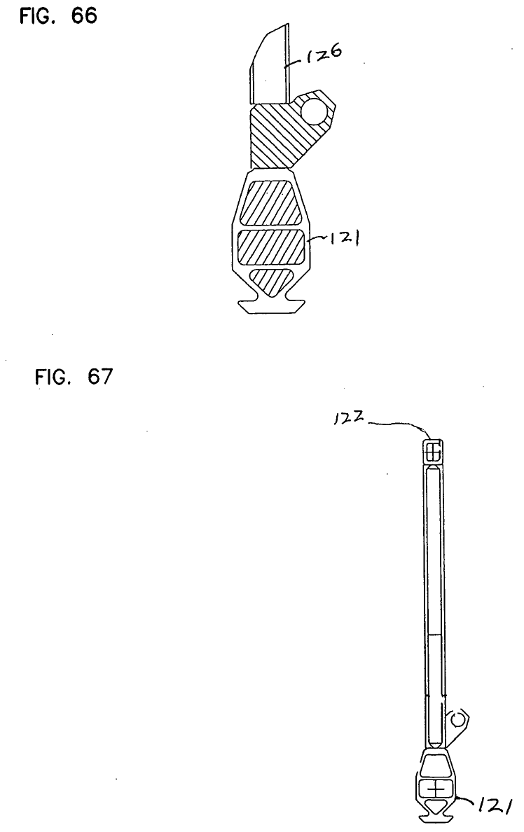

FIG. 66 is an enlarged, fragmentary, cross-sectional view taken along line 66-66, FIG. 62.

FIG. 67 is an end elevational view of one of the truss members utilized in ladder section 12.

FIG. 68, as previously discussed, is a schematic, side elevational view of a mobile ladder arrangement in telescoped condition, which utilizes ladder sections 10, 11, 12 having truss arrangements according to the present disclosure.

### V. General Ladder Truss Design Approach

In general, design of truss members for ladder sections of an extendible ladder arrangement according to the present disclosure, is conducted with a finite model analysis. A variety of computer software packages are available, for such analysis, including, for example, ProMechanica FEA software available from PTC (Parametric Technology Corp.), Needham, Mass. 02494.

In general, the truss design methods of the current disclosure (and resulting ladder truss structures) include recognition of the following factors:

1. a ladder section will be under different stresses, in extension from the base end to the top end;

2. It is preferred to have support members that are in compression relatively short; and,

3. It is preferred to have compression members in tension, be relatively long.

4. As the finite model shows those support members that will be under different stresses, they can be modified from one another with respect to support member cross-section and angle.

5. In a typical ladder arrangement utilizing principles described herein, vertical truss members are typically not needed except, in some instances, at or near the end of the truss member, where additional equipment or mounting will provide compression load between the top rail and the base rail at or near the end(s). For example in the truss arrangements described, a vertical truss member is used at the base end of the first or base ladder section, to manage forces of the trunnion plates attached thereto. Also, a vertical support member (as part of support 240) is used on the top fly or top section of the ladder arrangement, at the top end, as a support for the work platform supported thereon, to manage stresses applied by the work platform between the top rail and the base rail.

Except for such circumstances, generally load bearing vertical support members between the top rail and base rail can be avoided, to advantage, if desired.

### VI. Some General Comments

Herein, some example truss member arrangements utilizable in ladder sections are depicted and described. Typically, each truss member useable in a ladder section of an extendible ladder, in accord with specific examples of the present disclosure, comprises a base rail, a top rail and a support member arrangement extending between the base rail and a top rail. The support member arrangement includes a plurality of diagonal support members. The plurality of diagonal support members includes at least two (typically at least three) diagonal support members that differ from one another in some manner, for example with respect to an acute angle of extension relative to the base rail. In addition, the support member arrangement includes at least two (and typically at least three, often four or more) diagonal support members that differ from one another with respect to cross-sectional size.

Each truss member generally defines a first end, an opposite second end and a center equally positioned from the two ends. In an actual ladder section, one end of the truss member will be associated with the base end of the ladder section, the opposite of the truss member will be associated with the top or remote end of the ladder section.

Typically load bearing members of the truss member, i.e., the base rail, the top rail and support member arrangement, will comprise extruded, aluminum parts, typically having hollow interiors. The same aluminum material can be used for all of the extruded tubular aluminum parts.

In example truss members depicted herein, the support member arrangement includes a first plurality of spaced pairs of diagonal support members. Each pair of diagonal support members of the first plurality of spaced pairs of diagonal support members includes a first support member and a second support member, the first and second support members each extending from a vertex at or on the top rail extension to the base rail, while diverging from one another. The first plurality of spaced pairs, in an example shown, include at least four selected pairs of diagonal support members wherein in each one of the at least four selected pairs of diagonal support members a first support member is a short support member and a second member is a long support member. The terms “short” and “long” in this context refer to being compared in length to one another, within a given pair around a vertex at the top rail.

For the typical example truss member described herein, in each one of the at least four selected pairs of support members, the short support member is a compression member and the long support member is a tension member. By this it is meant that in accord with the finite model analysis, the truss, when under loads suspended from a location adjacent to a top end the truss member, i.e., when the truss member is used in a cantilever or pseudo-cantilever ladder section, the shorter support member of the identified pair is under compression and the longer support member of the identified pair is in tension.

For the example truss member arrangements described herein, the first plurality of selected pairs of diagonal support members include at least five of the selected pairs of diagonal support members, in accord with the general definition provided.

As discussed previously, in a typical truss member arrangement in accord with the example described herein, the truss member arrangement includes no more than two vertical support members, typically no more than one vertical support member and in some instances (for example a mid fly) no vertical support members.

Herein, example truss members are provided wherein the support member arrangement includes a second plurality of selected, spaced, pairs of diagonal support members, each pair of diagonal support members in the second plurality of selected, spaced, pairs of diagonal support members comprising third and fourth support members extending from a vertex at the top rail and diverging in extension to the base rail. The second plurality of selected, spaced, pairs including at least three selected pairs of support members wherein in each one of these three pairs of support members, the third support member is the same length as the fourth support member. In the examples, truss member 90, FIG. 5; and, truss member 120, FIG. 6, generally meet this characterization.

In each truss member that includes the identified second plurality of spaced pairs, generally there are not provided more than five selected pairs in the second plurality. In both truss member 90, FIG. 5 and truss member 120, FIG. 6, there are provided four of the second plurality of selected, spaced, pairs of support members as defined.

In the example truss members 90, FIG. 5 and truss member 120, FIG. 6, each pair of diagonal support members in the second plurality of spaced pairs of diagonal support members is located adjacent at least one other pair of diagonal support members in the second plurality of spaced pairs of diagonal support members; and, pairs of diagonal support members in the second plurality of spaced pairs of diagonal support members are positioned, sequentially, in a non-interrupted line. That is, each of the pairs is positioned adjacent another pair, with no pair therebetween that is not a member of the second plurality of spaced pairs of diagonal support members as defined.

Further, in the example truss arrangement 90, FIG. 5 and truss arrangement 120, FIG. 6, the support member arrangement includes no pair of support members (from a vertex at the top rail) comprising support members of equal length extending from the top rail to the base rail, which is not a member of the second plurality of spaced pairs of support members.

In the example truss member 90, FIG. 5 and truss member 120, FIG. 6, each pair of diagonal support members in the second plurality of spaced pairs of diagonal support members is positioned on the truss member at a location between a base end and a truss center, i.e., between an end of the truss member intended to be adjacent a base end of a ladder section, and a center of that same truss member or ladder section.

As indicated previously, generally in truss members according to the example truss member arrangements described herein, any vertical support present is an end support member in a line of support members positioned between the base rail and the top rail.

Further, in each of the truss member arrangements depicted in FIG. 4 (truss member 70), FIG. 5 (truss member 90) and FIG. 6 (truss member 120) each pair of truss members extending from a vertex on the top rail to the base rail (in which the vertex is located between the center of the truss and an end of the truss which will be a remote or top end when the truss is used in a ladder section), comprises first and second truss members in which one of the truss members (the first truss member) is shorter than the second truss member.

Herein, ladder sections for an extendible ladder, utilizing truss members in accord with the truss member descriptions provided, are described as examples. Three different ladder sections are shown, described and discussed. In general each ladder section comprises first and second sides, each side comprising a truss member in accord with one or more of the descriptions provided. Extending between the ladder sections, is a rung arrangement. Also provided herein are descriptions of an extendible ladder arrangement, comprising at least two ladder sections, and in an example shown three ladder sections, where in each ladder section includes first and second truss members in accord with the selected ones of the general characterizations herein.

Further, in FIG. 68, a mobile ladder arrangement is shown comprising a truck with a ladder arrangement in accord with the previous descriptions operably mounted thereon. By operably mounted thereon, it is meant that the ladder arrangement is mounted, at one end of a base ladder section, to a turn table arrangement, with other ladder sections telescopically received, for extension as depicted. Such a mobile ladder arrangement generally includes a working bucket or platform at a remote end from the turn table.

There is no requirement that an arrangement be in accord with all of the descriptions provided herein, to obtain some advantage.

### VII. Modifications to the Arrangements Characterized in U.S. 60/925,035

As characterized previously, the present application includes the disclosure of U.S. 60/925,035, with some additions and edits. Additional information is provided in the form of FIGS. 24A and 30A.

Referring to FIG. 24A, analogous parts to FIG. 24 are numbered analogously. A stiffener plate has been added at 300. At 301, a weld would be provided between the stiffener plate 300 and flange 166. The stiffener plate 300 and weld 301 will provide for distribution of load.

It is noted that an analogous plate to stiffener plate 300 and weld would be positioned adjacent an opposite end of flange 166.

Still referring to FIG. 24A, at 303 a conduit for wires, is depicted.

FIG. 30A is analogous to FIG. 24A, and same reference numerals are used. Stiffener plate 300 is depicted as well as weld joint 301 and conduit 303.

The provision of stiffener 300 adjacent flange 166, and an analogous stiffener adjacent an opposite end of flange 166 provides for strength and distribution of load, in an advantageous manner.

The principles characterized above in connection with FIGS. 24A and 30A can be implemented in arrangements otherwise in accord with the descriptions above.

What is claimed is:

1. A truss member for a ladder section in an extendible ladder; the truss member comprising:
(a) a base rail; a top rail; and, a support member arrangement extending between the base rail and the top rail;
(i) the support member arrangement including a plurality of diagonal support members; the plurality of diagonal support members including at least two diagonal support members that differ from one another with respect to acute angle of extension relative to the base rail.

2. A truss member according to claim 1 wherein:
(a) the support member arrangement includes at least two diagonal support members that differ from one another with respect to cross-sectional size.

3. A truss member according to claim 1 wherein:
(a) the support member arrangement includes a first plurality of spaced pairs of diagonal support members;
(i) each pair of diagonal support members in the first plurality comprising first support member and a second support member extending from a vertex at the top rail in extension to the base rail;
(ii) the first plurality of spaced pairs including at least four first selected pairs of diagonal support members where in each one of the four first selected pairs of diagonal support members a first member is a short support member and a second member is a long support member.

4. A truss member according to claim 3 wherein:
(a) in each one of the four first selected pairs of support members the short support member is positioned as a compression member and the long support member is positioned as a tension member.

5. A truss member according to claim 3 wherein:
(a) the first plurality of pairs of diagonal support members includes at least five of the first selected pairs of diagonal support members.

6. A truss member according to claim 1 wherein:
(a) the truss member includes no more than two vertical support members.

7. A truss member according to claim 6 wherein:
(a) the truss member includes no more than one vertical support member.

8. A truss member according to claim 7 wherein:
(a) the truss member includes no vertical support member.

9. A truss member according to claim 1 wherein:
(a) the support member arrangement includes a second plurality of spaced second selected pairs of diagonal support members;
(i) each pair of diagonal support members in the second plurality of spaced second selected pairs of diagonal support members comprising third and fourth support members extending from a vertex at the top rail in extension to the base rail;
(ii) the second plurality of spaced second selected pairs includes at least three selected second pairs of support members wherein:
(A) in each one of the at least three selected second pairs of supports members the third support member is the same length as the fourth support member.

10. A truss member according to claim 9 wherein:
(a) the second plurality of spaced second selected pairs of diagonal support members includes no more than five second selected pairs of diagonal support members.

11. A truss member according to claim 10 wherein:
(a) the second plurality of spaced second selected pairs of support members includes four second selected pairs of diagonal support members.

12. A truss member according to claim 9 wherein:
(a) each pair of diagonal support members in the second plurality of spaced second selected pairs of diagonal support members is located adjacent at least one other pair of diagonal support members in the second plurality of spaced second, selected, pairs of diagonal support members; and,
(b) the pairs of diagonal support members in the second plurality of spaced second selected pairs of diagonal support members are positioned, sequentially, in an uninterrupted line.

13. A truss member according to claim 12 wherein:
(a) the support member arrangement includes no pair of support members, comprising support members of equal length extending from a vertex at the top rail to the base rail, which is not a member of the second plurality of spaced second selected pairs of support members.

14. A truss member according to claim 12 wherein:
(a) the truss member includes a base end, a top end and a truss center; and,
(b) each pair of diagonal support members in the second plurality of spaced second selected pairs of diagonal support members is positioned in the truss member at a location between the base end and the truss center.

15. A truss member according to claim 1 wherein:
(a) the truss member includes a base end, a top end and a truss center; and,
(b) any vertical support present is an end support member.

16. A truss member according to claim 1 wherein:
(a) the truss member includes a base end, a top end and a truss center; and,
(b) each pair of support members comprising first and second diagonal support members extending from a vertex on the top rail to the base rail, in which the vertex is located between the truss center and the top end, comprises a pair of support members in which a first support member is shorter than a second support member.

17. A ladder section for an extendible ladder; the ladder section comprising:
(a) first and second, side, truss members with a rung arrangement extending therebetween;
(i) the first and second truss members having a set of support members oriented as mirror images of one another;
(ii) each truss member being in accord with claim 1.

18. An extendible ladder comprising:
(a) at least first and second ladder sections; the second ladder section being telescopically positioned on the first ladder section;
(b) each ladder section being in accord with claim 17.

19. An extendible ladder according to claim 18 wherein:
(a) the ladder includes first, second and third ladder sections telescopically arranged; and,
(b) each ladder section being in accord with claim 17.

20. A mobile ladder arrangement comprising:
(a) a truck with a ladder arrangement according to claim 18 operably mounted thereon.

21. A mobile ladder arrangement comprising:
(a) a truck with a ladder arrangement according to claim 19 operably mounted thereon.
